(19) United States
(12) Patent Application Publication
(10) Pub. No.: US 2007/0141525 A1
(43) Pub. Date: Jun. 21, 2007

(54) Registering banded appliances for digital orthodontics treatment planning

(76) Inventor: David K. Cinader, Jr., Yorba Linda, CA (US)

Correspondence Address: 3M INNOVATIVE PROPERTIES COMPANY, PO BOX 33427, ST. PAUL, MN, 55133-3427, US

(21) Appl. No.: 11/275,167

(22) Filed: Dec. 16, 2005

(51) Int. Cl. A61C 3/00

(52) U.S. Cl. 433/23; 433/24

(57) ABSTRACT

In general, the invention relates to techniques for registering a three-dimensional (3D) coordinate system of a physical model of a patient's tooth structure to a 3D coordinate system of a virtual model of the same tooth structure. Techniques are described to register the complex geometries of the physical and virtual tooth structures by using registration markers located on banded appliances previously fixed to or prepared to be fixed to the patient's teeth. Performing registration with banded appliances may enable more complete and accurate treatment planning.

### TECHNICAL FIELD

The invention relates to orthodontics and, more particularly, computer-based techniques for assisting orthodontic diagnosis and treatment.

### BACKGROUND

The field of orthodontics is concerned with repositioning and aligning a patient's teeth for improved occlusion and aesthetic appearance. For example, orthodontic treatment often involves the use of tiny slotted appliances, known as brackets, which are fixed to the patient's anterior, cuspid, and bicuspid teeth. An archwire is received in the slot of each bracket and serves as a track to guide movement of the teeth to desired orientations. The ends of the archwire are usually received in appliances known as buccal tubes that are secured to the patient's molar teeth.

A number of orthodontic appliances in commercial use today are constructed on the principle of the “straight wire concept” developed by Dr. Lawrence F. Andrews, D.D.S. In accordance with this concept, the shape of the appliances, including the orientation of the slots of the appliances, is selected so that the slots are aligned in a flat reference plane at the conclusion of treatment. Additionally, a resilient archwire is selected with an overall curved shape that normally lies in a flat reference plane.

When the archwire is placed in the slots of the straight wire appliances at the beginning of orthodontic treatment, the archwire is often deflected upwardly or downwardly from one appliance to the next in accordance with the patient's malocclusions. However, the resiliency of the archwire tends to return the archwire to its normally curved shape that lies in a flat reference plane. As the archwire shifts toward the flat reference plane, the attached teeth are moved in a corresponding fashion toward an aligned, aesthetically pleasing array.

In general, orthodontic appliances that are adapted to be adhesively bonded to the patient's teeth are placed on the teeth by either one of two methods: a direct bonding method, or an indirect bonding method. In the direct bonding method, the appliance and adhesive are grasped with a pair of tweezers or other hand instrument and placed by the practitioner on the surface of the tooth in an approximate desired location. Next, the appliance is shifted along the surface of the tooth as needed until the practitioner is satisfied with its position. Once the appliance is in its precise, intended location, the appliance is pressed firmly onto the tooth to seat the appliance in the adhesive. Excess adhesive in areas adjacent the base of the appliance is removed, and the adhesive is then allowed to cure and fix the appliance firmly in place. Typical adhesives include light-curable adhesives that begin to harden upon exposure to actinic radiation, and two-component chemical-cure adhesives that begin to harden when the components are mixed together.

While the direct bonding technique described above is in widespread use and is considered satisfactory by many, there are shortcomings that are inherent with such a technique. For example, access to surfaces of malposed teeth may be difficult. In some instances, and particularly in connection with posterior teeth, the practitioner may have difficulty seeing the precise position of the bracket relative to the tooth surface. Additionally, the appliance may be unintentionally bumped from its intended location during the time that the excess adhesive is being removed adjacent the base of the appliance.

Another problem associated with the direct bonding technique described above concerns the significant length of time needed to carry out the procedure of bonding each appliance to each individual tooth. Typically, the practitioner will attempt to ensure that each appliance is positioned in its precise, intended location before the adhesive is cured, and some time may be necessary before the practitioner is satisfied with the location of each appliance. At the same time, however, the patient may experience discomfort and have difficulty in remaining relatively motionless, especially if the patient is an adolescent. As can be appreciated, there are aspects of the direct bonding technique that can be considered a nuisance for both the practitioner and for the patient.

Indirect bonding techniques often avoid many of the problems noted above. In general, indirect bonding techniques known in the past have involved the use of a transfer tray having a shape that matches the configuration of at least part of a patient's dental arch. A set of appliances such as brackets are releasably connected to the tray at certain, predetermined locations. Adhesive is applied to the base of each appliance, and the tray is then placed over the patient's teeth until such time as the adhesive hardens. Next, the tray is detached from the teeth as well as from the appliances, with the result that all of the appliances previously connected to the tray are now bonded to the respective teeth at their intended, predetermined locations.

In more detail, one method of indirect bonding of orthodontic appliances includes the steps of taking an impression of each of the patient's dental arches and then making a replica plaster or “stone” model from each impression. Optionally, a soap solution (such as Model Glow brand solution from Whip Mix Corporation) or wax is applied to the stone model. A separation solution (such as COE-SEP brand tinfoil substitute from GC America, Inc.) is then applied to the stone model and allowed to dry. If desired, the teeth of the model can be marked with a pencil to assist in placing the brackets in ideal positions.

Next, the brackets are bonded to the stone models. Optionally, the bonding adhesive can be a chemical curing adhesive (such as Concise brand adhesive from 3M) or a light-curable adhesive (such as Transbond XT brand adhesive or Transbond LR brand adhesive, from 3M). Optionally, the brackets may be adhesive precoated brackets such as those described in U.S. Pat. Nos. 5,015,180, 5,172,809, 5,354,199 and 5,429,229.

A transfer tray is then made by placing a matrix material over the model as well as over the brackets placed on the model. For example, a plastic sheet matrix material may be held by a frame and exposed to radiant heat. Once the plastic sheet material has softened, it is placed over the model and the brackets. Air in the space between the sheet material and the model is then evacuated, and the plastic sheet material assumes a configuration that precisely matches the shape of the replica teeth of the stone model and the attached brackets.

The plastic material is then allowed to cool and harden to form a tray. The tray and the brackets (which are embedded in an interior wall of the tray) are then detached from the stone model and sides of the tray are trimmed as may be desired. Once the patient has returned to the office, a quantity of adhesive is placed on the base of the bracket, and the tray with the embedded brackets is then placed over the matching portions of the patient's dental arch. Since the configuration of the interior of the tray closely matches the respective portions of the patient's dental arch, each bracket is ultimately positioned on the patient's teeth at precisely the same location that corresponds to the previous location of the same bracket on the stone model.

Both light-curable adhesives and chemical curing adhesives have been used in the past in indirect bonding techniques to secure the brackets to the patient's teeth. If a light-curable adhesive is used, the tray is preferably transparent or translucent. If a two-component chemical curing adhesive is used, the components can be mixed together immediately before application of the adhesive to the brackets. Alternatively, one component may be placed on each bracket base and the other component may be placed on the tooth surface. In either case, placing of the tray with the embedded brackets on corresponding portions of the patient's dental arch enables the brackets to be bonded to the teeth as a group using only a short amount of time that the patient is occupying the chair in the operatory. With such a technique, individual placement and positioning of each bracket in seriatim fashion on the teeth is avoided.

A variety of transfer trays and materials for transfer trays have been proposed in the past. For example, some practitioners use a soft sheet material (such as Bioplast tray material from Scheu-Dental GmbH or Great Lakes Orthodontics, Ltd.) for placement over the stone model and the appliances on the model. Either a vacuum or positive pressure is applied to respectively pull or push the soft material into intimate contact with the model and the appliances on the model. Next, a stiffer sheet material (such as Biocryl sheet material, from Scheu-Dental GmbH or Great Lakes Orthodontics, Ltd.) is formed over the softer sheet material, again using a either a vacuum or positive pressure forming technique. The stiffer material provides a backbone to the tray, while the softer material initially holds the appliances and yet is sufficiently flexible to release from the appliances after the appliances have been fixed to the patient's teeth.

It has also been proposed in the past to use a silicone impression material or a bite registration material (such as Memosil 2, from Heraeus-Kulzer GmbH-& Co. KG). The silicone material is applied over the appliances that are attached to the study model so that the appliances are partially encapsulated.

In an article entitled “A New Look at Indirect Bonding” by Moskowitz et al. (Journal of Clinical Orthodontics, Volume 30, Number 5, May 1996, pages 277 et sec.), a technique for making indirect bonding trays is described using Reprosil impression material (from Dentsply International). The impression material is placed with a syringe over brackets that have been previously placed on a stone model. Next, a sheet of clear thermoplastic material is drawn down over the impression material using a vacuum-forming technique. The resultant transfer tray is then removed from the model for subsequent placement on the patient's dental arch.

Indirect bonding techniques offer a number of advantages over direct bonding techniques. For one thing, and as indicated above, it is possible to bond a plurality of brackets to a patient's dental arch simultaneously, thereby avoiding the need to bond each appliance in individual fashion. In addition, the indirect bonding tray helps to locate all of the brackets in their proper, intended positions such that adjustment of each bracket on the surface of the tooth before bonding is avoided. The increased placement accuracy of the appliances that is often afforded by indirect bonding techniques helps ensure that the patient's teeth are moved to their proper, intended positions at the conclusion of treatment. In addition, accurate knowledge of tooth position in the patient's dental arch together with slot registration of banded appliances and an attached appliance archwire allows digital treatment planning to correctly predict the finished positions of the teeth in the dental arch.

The state of the art in orthodontics is rapidly moving toward digital and computer-aided techniques. These techniques include the use of intra and extra-oral scanners, three-dimensional (3D) modeling of a tooth structure, and fabrication of orthodontic devices from digital data.

### SUMMARY

In general, the invention relates to techniques for registering a three-dimensional (3D) coordinate system of a physical model of a patient's tooth structure to a 3D coordinate system of a virtual model of the same tooth structure. Techniques are described to register the complex geometries of the physical and virtual tooth structures by using registration markers associated with the physical model. The registration markers may be located on banded appliances to enable alignment of the banded appliances to banded appliances in the virtual model. Integrating tooth and banded appliance position may increase the accuracy of digital treatment planning.

In one example, registration markers are placed on banded appliances attached to one or more teeth of a patient prior to forming an impression of the patient's teeth. In another example, a scan of teeth with markers placed on banded appliances is used to create a digital model and casting of the teeth. Scanning the teeth, impression, or casting with markers generates a digital model of the tooth structure containing markers. The locations of the registration markers may then assist registration of the coordinate system of the physical model to the coordinate system of the 3D digital model for creation of a digital orthodontic prescription for the patient. The orthodontic prescription includes an indirect bonding tray with any combination of brackets or banded appliances that may be fitted to the patient's teeth in the appropriate placement.

In one embodiment, the disclosure provides a method including attaching one or more banded appliances to a tooth structure of a patient, wherein the one or more banded appliances each comprise a marker, forming an impression of the patient's tooth structure having the markers, and registering the impression to a digital model of the tooth structure based on known locations of the markers.

In another embodiment, the disclosure provides a method including attaching one or more banded appliances to a tooth structure of a patient, scanning the patient's tooth structure with the one or more banded appliances attached to the tooth structure, generating a digital model of the tooth structure from the scan based on known locations of the banded appliances, and generating a casting based upon the digital model.

In an alternative embodiment, the disclosure provides a method including attaching markers to a tooth structure of a patient, forming an impression of a tooth structure of a patient having the attached markers, registering the impression to a digital model of the tooth structure based on known location of the markers, generating a casting from the impression, and utilizing a robotic manufacturing device for automatic placement of banded appliances onto the casting.

In another embodiment, the disclosure provides a system including a marker attached to each of one or more banded appliances attached to a tooth structure of a patient, an impression of the tooth structure having the attached banded appliances, and a computer that registers the impression to a digital model based on known locations of the markers.

In another embodiment, the disclosure provides an orthodontic banded appliance including a metallic hemispherical marker and a bonding pad attached to the metallic hemispherical marker for bonding to the orthodontic banded appliance.

In another embodiment, the disclosure provides an orthodontic banded appliance including a light transmitting marker and a bonding pad attached to the light transmitting marker for bonding to the orthodontic banded appliance.

In another embodiment, the disclosure provides an orthodontic device comprising an indirect bonding tray that is formed around a casting of a tooth structure of a patient, one or more brackets embedded in the indirect bonding tray, and one or more banded appliances embedded in the indirect bonding tray.

The invention may provide one or more advantages. For example, the techniques may provide for assisted (e.g., automatic or semi-automatic) registration of physical and virtual models used during indirect bonding tray fabrication. Assisted registration may reduce the labor, cost, and probability of error during manufacturing of an orthodontic appliance, such as an indirect bonding tray. Including pre-attached banded appliances in a digital model may increase the accuracy of a planned treatment while adding banded appliances to an indirect bonding tray may increase the accuracy of banded appliance attachment as prescribed in the planned treatment.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary computer environment 2 in which a clinic and a manufacturing facility communicate information throughout an indirect bonding tray manufacturing process.

FIG. 2 is a flow diagram illustrating an exemplary process at a clinic.

FIGS. 3A and 3B are flow diagrams illustrating an exemplary process at an indirect bonding device manufacturing facility.

FIG. 4 is a perspective view of an exemplary pedestal of known geometry.

FIGS. 5A and 5B are perspective views of a digital model of a casting attached to a pedestal.

FIG. 6 is a perspective view of an exemplary fixture of a robotic device.

FIG. 7 is a perspective view of an exemplary pedestal with attached model mated to an exemplary fixture of a robotic device.

FIG. 8 is a side elevation view of an exemplary casting assembly.

FIG. 9 is a flow diagram of an exemplary process according to one embodiment of the invention.

FIGS. 10A and 10B are an occlusal and distal view respectively of an exemplary impression tray with three hemispherical dimples.

FIGS. 11A and 11B are a top and rear elevation view respectively of an exemplary main pedestal with three pillars.

FIGS. 12A and 12B are a top and rear elevation view respectively of an exemplary impression tray attached to an exemplary main pedestal.

FIG. 13 is a rear elevation view of an exemplary enclosing wall resting on a main pedestal with attached impressions.

FIG. 14 is a top view of an exemplary inverted pedestal drilled with holes and tapped with machine threads.

FIG. 15 is a rear elevation view of an exemplary inverted pedestal fitted and properly aligned with screws strategically located and threaded into the casting material, upon a main pedestal, with an enclosing wall.

FIG. 16 is an inverted rear elevation view of an exemplary inverted pedestal with screws securing the position of the solid casting.

FIG. 17 is a flow diagram illustrating an exemplary process at a clinic, distinguishable from FIGS. 3A and 3B by the placement of marker brackets at the clinic.

FIG. 18 is a perspective view of an exemplary metallic hemispherical marker bracket.

FIG. 19 is a perspective view of an exemplary marker tool for attaching marker brackets to a patient's tooth.

FIG. 20 is a cross section of an exemplary hemispherical cup in bell housing of a marker tool.

FIG. 21 is a perspective view of an exemplary surfaced 3D digital model with a marker bracket.

FIG. 22 is a perspective view of an exemplary CNC machined plate with a surface profile machined into it.

FIG. 23 is a side view of a casting set into the machined surface of an exemplary plate.

FIG. 24 is a perspective view of a casting set into the machined surface of an exemplary plate.

FIGS. 25A and 25B are perspective views of exemplary patient tooth structure with banded appliances.

FIG. 26 is a flow diagram illustrating an exemplary technique to make a dental impression of teeth with banded appliances.

FIG. 27 is a perspective view of exemplary banded appliances blocked out with wax.

FIGS. 28A and 28B are flow diagrams illustrating an exemplary technique for creating indirect bonding trays.

FIG. 29 is a flow diagram illustrating an exemplary technique for scanning teeth with banded appliances.

FIG. 30 is a flow diagram illustrating an exemplary technique for selecting banded appliances.

FIG. 31 is a perspective view of an exemplary indirect bonding tray with banded appliances.

FIG. 32 is a flow diagram of an exemplary technique for checking banding appliance placement.

### DETAILED DESCRIPTION

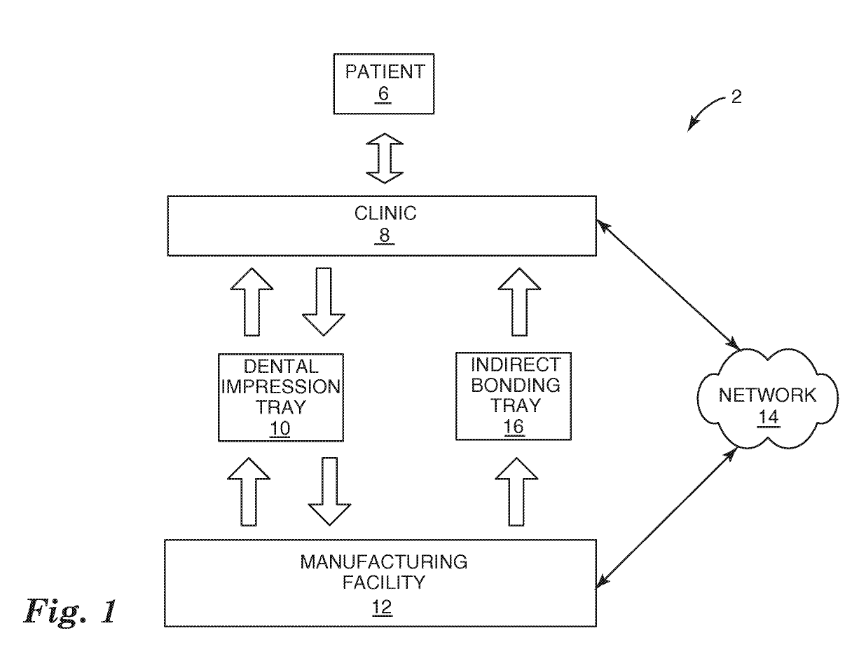

FIG. 1 is a block diagram illustrating an exemplary computer environment 2 in which a clinic and a manufacturing facility communicate information throughout an indirect bonding tray manufacturing process. Although described with respect to manufacturing of indirect bonding trays, the techniques may be applied to other computer-implemented processes for assisting orthodontic diagnosis and treatment.

Initially, manufacturing facility 12 produces a dental impression tray 10 for receiving dental impressions of a dental arch or other tooth structure of patient 6. Manufacturing facility 12 ships dental impression tray 10 to clinic 8. The dental impression tray 10 is loaded with a quantity of impression material just prior to taking the impression at clinic 8, or alternatively is preloaded with quantity of impression material by the manufacturer before shipment to the clinic. Impression tray 10 is adapted to extend along the entire dental arch, although as an alternative it is possible to use an impression tray that extends along a fewer number of teeth such as a dental quadrant.

An orthodontic practitioner of clinic 8 utilizes dental impression tray 10 to capture an impression of the dental arch of patient 6. Clinic 8 stores digital information in a patient record within a database to associate the patient record with the particular dental impression tray 10. Clinic 8 may, for example, update a local database having a plurality of patient records. Alternatively, clinic 8 may remotely update a central database within manufacturing facility 12 via network 14.

In either case, clinic 8 then returns dental impression tray 10 to manufacturing facility 12. Manufacturing facility 12 utilizes dental impression tray 10 to construct an indirect bonding tray 16 for use in physically placing brackets on the teeth of patient 6.

Construction of indirect bonding tray 16 involves a multi-step process conducted at manufacturing facility 12. First, manufacturing facility 12 creates a casting from dental impression tray 10. The term “casting” is used generally herein to refer to any type of physical model made from dental impression tray 10, for example, a replica made from plaster of Paris or from a polymeric material such as an epoxy that transmits actinic radiation. Suitable epoxy and other polymeric materials are described in published U.S. patent application 20040219473, which is incorporated by reference herein. The term “casting” is also used generally herein to refer to a physical model of predicted tooth positions, such as a stereolithographic model used in the fabrication of tooth positioning trays. Examples of tooth positioning trays include those sold by Align Technology of Santa Clara, Calif. and those described in U.S. Pat. Nos. 6,309,215 and 6,705,863, both of which are incorporated by reference herein. Optionally, in instances where a digital model of the entire arch is not needed, the casting may include a fewer number of teeth than the number of teeth represented in the impression.

In certain embodiments, the casting contains or is affixed to one or more registration components having known physical characteristics. The registration components may have been placed into the impression tray at clinic 8 and transferred to the casting or may have been attached to or embedded within the casting at manufacturing facility 12.

Next, manufacturing facility 12 scans the casting or the impression with one or more registration components to generate a three-dimensional (3D) digital model of the tooth structure. Multiple castings or impressions may be scanned simultaneously to reduce the number of scans. For example, scanning a casting of a patient's upper jaw along with a casting of the patient's lower jaw and bite impression enables registration of the models relative to each other (for setting the bite) along with registration of the castings to the virtual models all in a single scan. The registration components enable manufacturing facility 12 to utilize the digital model for receiving prescription data and bracket placement data from clinic 8 in order to automatically place brackets onto the casting per the clinic's specifications. Manufacturing facility 12 then forms indirect bonding tray 16 from the casting with the affixed brackets. Lastly, manufacturing facility 12 forwards indirect bonding tray 16 to clinic 8 for use in a conventional indirect bonding procedure to place the brackets on the teeth of patient 6.

Manufacturing facility 12 may produce indirect bonding tray 16 by placing a matrix material in the form of a plastic sheet over the casting and the brackets and exposing the matrix material to radiant heat. Air in the space between the sheet material and the casting is then forced out by a pressure differential between the inner and outer surfaces of the sheet material (i.e. either by vacuum forming or positive pressure forming), and the plastic sheet material assumes a configuration that precisely matches the shape of the replica teeth of the casting and the attached brackets. Suitable indirect bonding trays and methods for making indirect bonding trays are described, for example, in copending and commonly assigned U.S. Patent Publication No. 2004/0219471 entitled “Method and Apparatus for Indirect Bonding of Orthodontic Appliances”, published Nov. 4, 2004 to Cleary et al., Publication No. 2004/0219473 entitled “Orthodontic Appliances Having a Contoured Bonding Surface”, published Nov. 4, 2004 to Cleary et al., and Publication No. 2005/0074717 entitled “Method and Apparatus for Bonding Orthodontic Appliances to Teeth”, published Apr. 7, 2005 to Cleary et al., Ser. No. 11/098317 entitled “Method of Making Indirect Bonding Apparatus for Orthodontic Therapy”, filed Apr. 4, 2005 to Cinader et al., and Ser. No. 11/098716 entitled “Othodontic Indirect Bonding Apparatus with Occlusal Positioning Stop Members”, filed Apr. 4, 2005 to Cinader et al., all of which are entirely incorporated herein by reference.

As further described, techniques may be used to assist (e.g., automatically or semi-automatically) registration of a physical model to a corresponding digital model for automated appliance manufacturing, such as manufacturing of an indirect bonding device from the casting. For example, the techniques involve attaching or embedding one or more registration components of known physical characteristic to a physical model of a patient's tooth structure (e.g., a dental impression, bite registration, or casting) prior to scanning the physical model. For example, the registration component may be a pedestal of known geometry, a pedestal with embedded fiducial markers at known locations, a pedestal attached to an impression tray containing dimples at known locations, a group of three or more tooth markers placed directly on a select number of a patient's teeth prior to forming the impression, a group of one or more tooth markers attached to orthodontic bands attached to a select number of the patient's teeth prior to forming the impression, or a group of three or more tooth markers placed on an impression or casting after forming the impression or casting. The phrase “patient's tooth structure” is used generally herein to refer to a replica of the patient's current tooth structure and alternatively to a replica of the patient's predicted tooth structure such as may be expected to occur after orthodontic treatment has commenced.

After scanning the physical model with attached registration component or components, a computer registers the coordinate system of the physical model to the coordinate system of the digital model using the known geometry of the pedestal or the known location of the fiducial markers within the pedestal or within the impression tray. Furthermore, the computer may use the known geometry or known location of the registration components to register the coordinate systems of the physical and digital models to the coordinate system of a manufacturing device for automatic bracket placement onto the casting. Lastly, an indirect bonding device is formed upon the casting with the attached brackets.

The invention may provide one or more advantages. The techniques may provide for assisted registration of physical and virtual models used during manufacturing of an orthodontic appliance, such as an indirect bonding tray, an individual or set of machined orthodontic brackets, a buccal tube, a sheath, a button, an arch wire or other orthodontic appliances. The techniques may also enable simultaneous scanning of multiple components utilized during the virtual modeling and automatic bracket placement process. Automatic registration and simultaneous scanning may reduce the labor, cost, and probability of error during multiple steps of orthodontic appliance manufacturing, such as scanning, registering, virtual bracket placement, physical bracket placement, trimming of an indirect bonding tray or machining an appliance. The invention may also enable the use of roughly formed castings, thereby eliminating the expense of machining plaster casts.

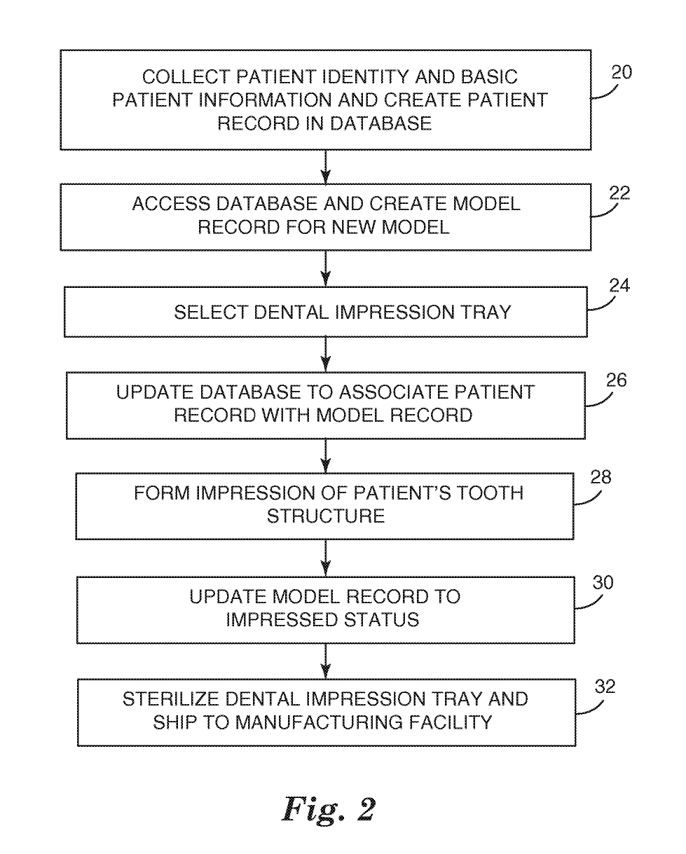

FIG. 2 is a flow diagram illustrating a process conducted at clinic 8 in accordance with one embodiment of the invention. Initially, practitioner at clinic 8 collects patient identity and other information from patient 6 and creates a patient record (20). As described, the patient record may be located within clinic 8 and optionally configured to share data with a database within manufacturing facility 12. Alternatively, the patient record may be located within a database at manufacturing facility 12 that is remotely accessible to clinic 8 via network 14.

When capturing an impression of the tooth structure of patient 6, or shortly before or after, practitioner at clinic 8 creates a model record for the new model (22). In the field of orthodontics, the term model refers to any replication of the patient's tooth structure, for example the impression, bite registration, the casting, and/or the 3D digital model of the tooth structure. Practitioner at clinic 8 selects a dental impression tray (24) and then updates the database to associate the appropriate patient record with the model record (26). This model record resides in the database and tracks the status and all variations of data of the patient's tooth structure. The practitioner of clinic 8 then utilizes dental impression tray 10 to form an impression of the patient's tooth structure (28) and updates the model record to the “impressed” status (30). Often times a patient requires orthodontic treatment on both the upper and lower arches. In this case, practitioner at clinic 8 selects impression tray 10 for each arch (24), forms an impression of each arch (28), associates a model record with each arch (26), and updates model record to “impressed” status for each arch (30). Clinic 8 sterilizes or disinfects impression tray 10 and ships the tray to manufacturing facility 12 (32).

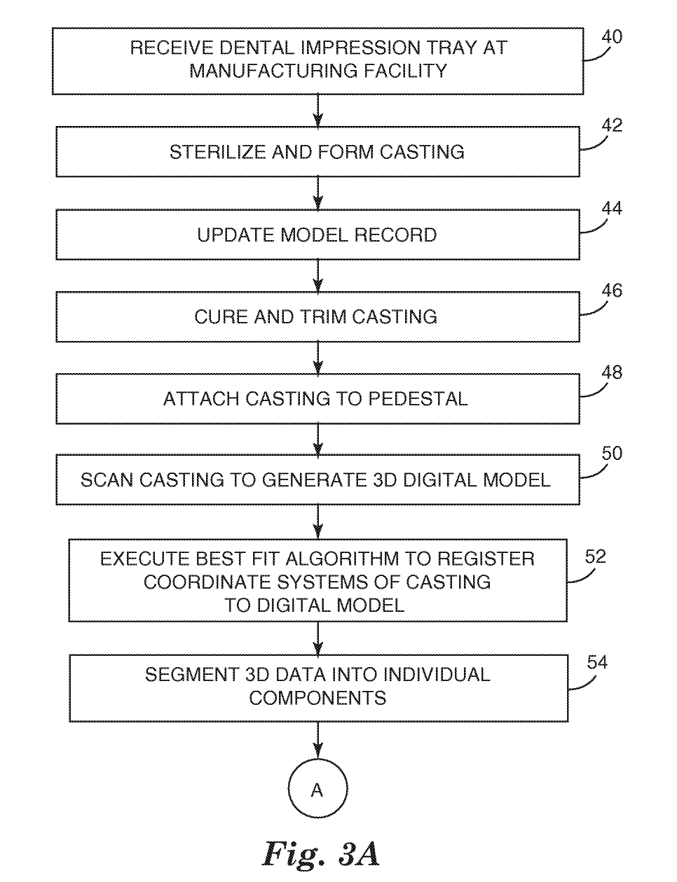

FIGS. 3A and 3B are flow diagrams illustrating a process performed by manufacturing facility 12 in accordance with one embodiment of the invention. Manufacturing facility 12 typically receives dental impression tray 10 as part of a larger shipment containing multiple dental impressions (40). Next, manufacturing facility 12 sterilizes or disinfects the shipment of impression trays, including dental impression tray 10, and moves the dental impression trays to a casting station where castings are made from the trays (42). Manufacturing facility 12 then utilizes the same database accessed by clinic 8 to update the model record to indicate a “casting formed” status (44). Next, manufacturing facility 12 cures and trims the casting (46).

In this example, manufacturing facility 12 then attaches a pedestal having known physical characteristics to the casting (48). In one embodiment, the pedestal has a known geometry. Alternatively, or in addition, the pedestal may have embedded fiducial markers, dimples or other physical characteristics. The pedestal may be constructed from plastic, but may alternatively be constructed of other materials. Next, manufacturing facility 12 may utilize a Computed Tomographic (CT) scanner to scan the casting (50). The casting may also be scanned with X-rays, magnetic resonance images or other scanning devices including those that utilize visible light. In cases where a patient requires orthodontic treatment on both the upper and lower arches, castings of the upper and lower arches may be scanned simultaneously (50). The scan generates a point cloud data file which manufacturing facility 12 then surfaces using one of several software packages available on the market today. For example, manufacturing facility 12 may utilize a software package called “Wrap” or “Studio” available from Raindrop Geomagic, Inc. of Durham, N.C. Once the point cloud is surfaced, a 3D digital model of the casting with pedestal exists in the computer.

Manufacturing facility 12 then executes a best fit algorithm for automatic or semi-automatic registration between a 3D coordinate system of the physical casting and a 3D coordinate system associated with the digital model of the casting within a 3D modeling environment (52). A computer may automate the registration process by temporarily masking out the casting data to determine a best fit between the scanned pedestal data in a point cloud format and a pre-existing Computer Aided Design (CAD) file of the pedestal of known geometry. For example, the computer may test numerous orientations of the scanned data of the physical pedestal relative to the pedestal CAD data. The registration is complete when the computer determines the best-fit orientation within a predetermined tolerance. This process may be fully automated or semi-automated in that user verification or other input may be requested. The computer then unmasks the casting data within the 3D modeling environment. The best-fit algorithm may be further simplified by attaching the pedestal of the known geometry to a fixture in the scanner prior to scanning the pedestal and the casting. In this manner, the scan may be automatically produced in a relatively known orientation, and the best fit algorithm may be initialized based on this known orientation.

Once the coordinate systems of the physical casting and digital model of the casting are registered within the 3D environment (52), manufacturing facility 12 utilizes software to segment the digital model into individual components prior to virtual bracket placement on the digital model (54). The separation software identifies each tooth and separates the teeth from each other and from the gingiva within the 3D environment. This may be useful in allowing each tooth to independently move within the 3D environment and illustrate the predicted results of any orthodontic prescription.

Manufacturing facility 12 then imports the 3D data for each component from the digital model into the database's model record (56) and communicates model record to clinic 8 (58). After clinic 8 utilizes the model record for virtual bracket placement, manufacturing facility 12 receives prescription data and virtual placement data from clinic 8 (60). The prescription data specifies the individual appliances (e.g. brackets or arch wires) associated with the prescription, and the virtual placement data specifies the location of the appliances within the 3D modeling environment.

Next, the physical casting and affixed pedestal travels to a manufacturing station within manufacturing facility 12, where appliances are automatically selected and applied to the casting based on the prescription data and virtual placement data (62). The registration determined between the physical casting and the virtual model of the casting may be used to ensure accurate positioning of the appliances. Further, the pedestal attached to the casting may securely mate with a predefined fixture within the manufacturing equipment to further ensure accurate appliance placement on the physical casting. Example robotic placement devices are described in commonly assigned U.S. Pat. No. 6,123,544, entitled “Method and apparatus for precise bond placement of orthodontic appliances”, issued Sep. 26, 2000 to James D. Cleary, and U.S. patent application Ser. No. 11/015368, entitled “RFID tracking of patient-specific orthodontic materials,” filed Dec. 17, 2004, both of which are hereby incorporated by reference.

After the manufacturing equipment attaches brackets to the casting, the manufacturing facility 12 forms an indirect bonding tray (64). For example, manufacturing facility 12 may place a heated plastic sheet matrix material over the casting and the brackets so that plastic sheet material assumes a configuration that precisely matches the casting.

Next, manufacturing facility 12 trims the indirect bonding tray (66). Manufacturing facility 12 may utilize automated tray trimming equipment, such as laser or Computer Numerical Control (CNC) cutting devices, to trim the indirect bonding tray. The known geometry of the pedestals registers the coordinate system of the casting with the coordinate system of the tray trimming equipment for trimming the indirect bonding tray while it remains attached to the casting. Since the indirect bonding tray is formed on a casting that is attached to a pedestal of known geometry, the coordinate system associated with the digital representation of the casting may be transferred to a model of the indirect bonding tray, which may in turn be used to automatically control the tray trimming equipment for trimming the indirect bonding tray. At the completion of the indirect bonding tray trimming, manufacturing facility 12 updates the model record to the “trimmed” status (68). Finally, manufacturing facility 12 ships indirect bonding tray 16 to clinic 8 (70).

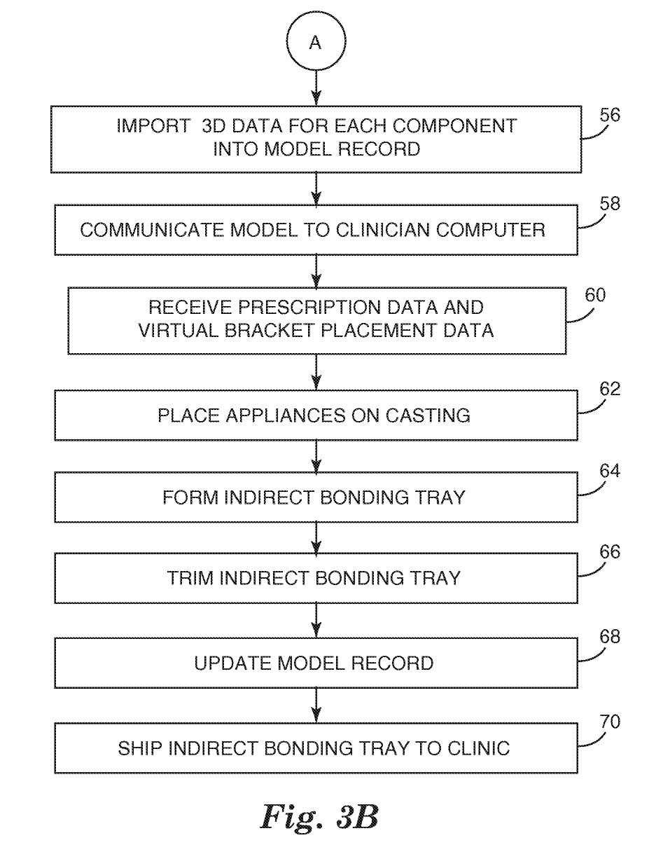

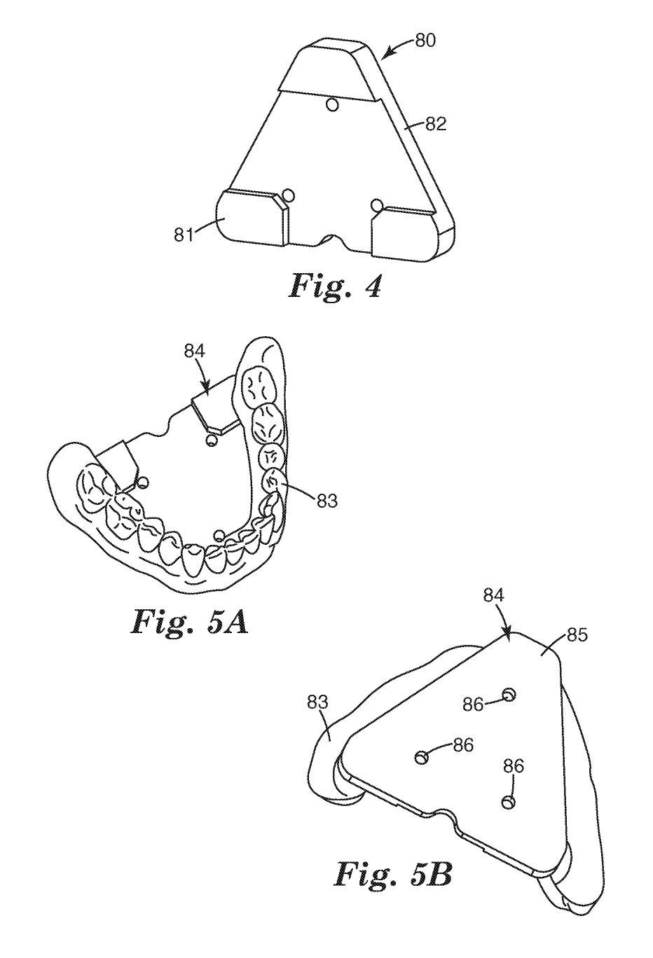

FIG. 4 is a perspective view of an exemplary pedestal 80 of known geometry. Pedestal 80 may be of any shape of known geometry that is able to be manufactured within a specified tolerance. Accordingly, the invention is not limited to the shape and physical characteristics of pedestal 80 illustrated in FIG. 4. Manufacturing facility 12 attaches the casting to a first surface 81 illustrated in FIG. 4. The attachment may be performed in many ways, such as bonding with an adhesive or epoxy, welding by melting and re-solidifying portions of one or both surfaces, screwing, snap-fitting protrusions on the pedestal into holes in the casting, latching, clamping, and the like. A reverse surface 82 of pedestal 80 may be formed to mate with a fixture of manufacturing equipment, such as a robotic device, for automatic bracket placement.

FIGS. 5A and 5B illustrate perspective views of the digital model of a casting 83 attached to a pedestal 84 within a 3D environment. For purposes of illustration, digital pedestal 84 is the digital version of the physical pedestal 80 illustrated in FIG. 4. FIG. 5A illustrates a perspective top view of casting 83 attached to pedestal 84. FIG. 5B illustrates a perspective bottom view of pedestal 84 with the attached casting 83. The bottom surface 85 of pedestal 84 includes three recesses 86 that mate with manufacturing equipment for automatic bracket placement.

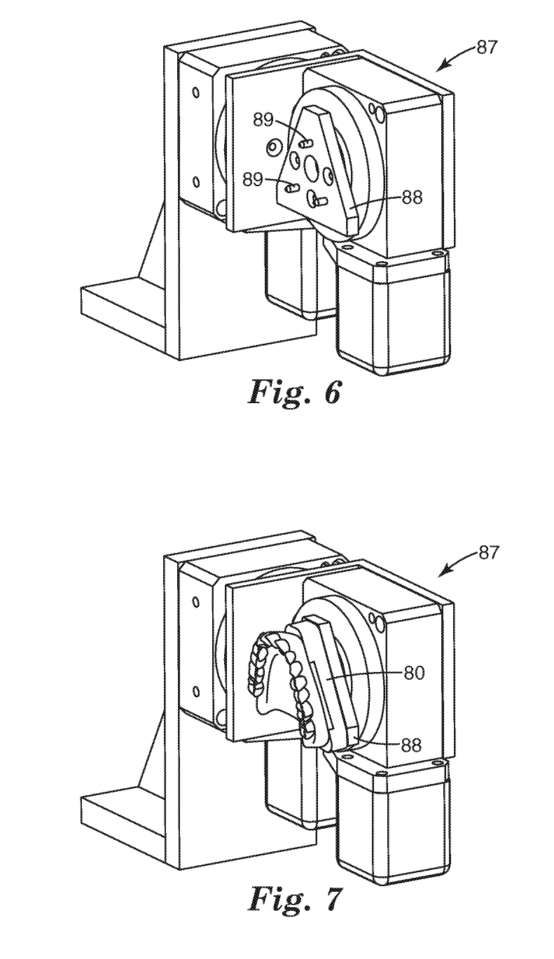

FIG. 6 illustrates a perspective view of an exemplary fixture of a robotic device 87. In this example, fixture 88 includes three pegs 89 that mate with recesses 86 of pedestal 80. (FIGS. 4, 5A and 5B). Fixture 88 may be of any shape that securely fixes a pedestal within a relatively known orientation; thus, the invention is not limited to the fixture illustrated in FIG. 6.

FIG. 7 illustrates a perspective view of an exemplary pedestal 80 mating to the exemplary fixture 88 of the robotic device 87. The mating of the physical pedestal to the robotic device fixture aligns the physical pedestal in a known orientation relative to robotic device 87. Robotic device may then utilize the registered coordinate systems of the digital models of the pedestal and the casting to place brackets on the physical casting based on the prescription data provided by the clinic.

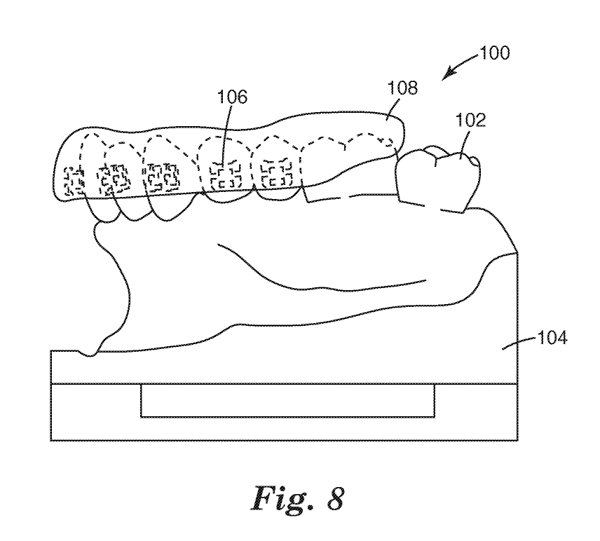

FIG. 8 is a side elevation view of an exemplary casting assembly 100. The casting assembly 100 includes casting 102 on pedestal 104 with attached brackets 106, and an indirect bonding tray 108 formed over casting 102.

In another embodiment, a pedestal having embedded fiducial markers may be used to assist registration. For example, the pedestal may be constructed from plastic and have three or more beads embedded at known locations within the pedestal. The beads may be constructed of steel, lead, or any other material that may be detected by a scanning device and distinguished from the surrounding pedestal. The computer detects the scanned beads, and registers the physical model of the casting to the virtual model of the casting based on the known location of the fiducial markers within the pedestal. The process (described in FIGS. 2, 3A and 3B) and the advantages described herein apply to this alternative technique.

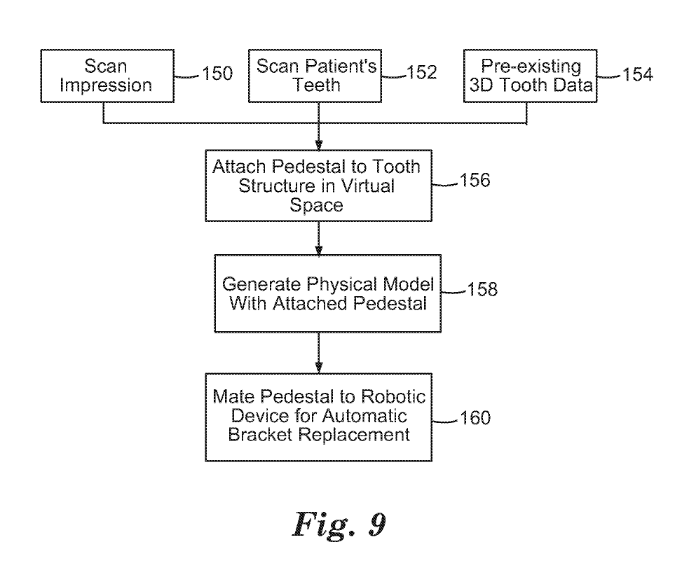

FIG. 9 is a flow diagram illustrating an exemplary process according to another embodiment of the invention in which a virtual pedestal of known geometry is attached to a digital tooth structure in a virtual environment. This process begins with a digital tooth structure generated by one of three techniques: scanning an impression of a patient's tooth structure (150), scanning the patient's teeth with an intra-oral scanner (152), or utilizing existing 3D tooth data (154). A user attaches a pre-existing CAD file of the pedestal to the digital tooth structure via software in the virtual environment (156). A rapid prototyping technique, such as stereolithography, utilizes the virtual tooth structure with attached pedestal to generate a physical model with attached pedestal (158). A user mates the physical pedestal to a robotic device for automatic bracket placement onto the physical model (160). As previously described, an orthodontic appliance, such as an indirect bonding tray, may be fabricated from the physical model with attached brackets.

In another embodiment, multiple components used during the process may be scanned in a specific sequence. For example, castings of the upper and lower arches, each with attached pedestals, may be sequentially scanned along with the patient's bite impression in the following sequence. First, an operator calibrates the scanner coordinate system to coincide with that of the CAD model of the pedestals, where the upper and lower pedestals are identical. An operator then scans the lower arch with pedestal, mates the bite impression to the lower arch, mates the upper arch to the bite impression, and then scans the upper arch with pedestal. Next, the operator uses software, such as Raindrop Geomagic Studio Best-Fit Alignment feature, to select only the upper arch pedestal from the upper arch scan data. The operator then uses the same software to align the virtual upper arch pedestal to the CAD model of the pedestal and records the transform. Next, the operator removes the lower arch from the scanner, scans just the upper arch with pedestal, and transforms the upper arch data points according the transform executed after the upper arch pedestal alignment step described above. This embodiment may be useful when utilizing optical scanners, which can only scan unobscured, visible surfaces. In addition to the advantages described herein, further advantages may include a method for semi-automatically setting the orientation between the upper and lower arches.

In another embodiment, multiple components used during the process may be simultaneous scanned. For example, castings of the upper and lower arches, each with attached pedestals, may be simultaneously scanned. In addition to the advantages described herein, further advantages may include a reduction in labor and cost by scanning all objects necessary for virtual bracket placement in a single scan, and a method for automatically or semi-automatically setting the orientation between the upper and lower arches by simultaneously scanning the two castings that are set in maximum intercuspation.

Furthermore, the invention may also enable simultaneous scanning of multiple castings, each with attached pedestal, and a bite impression, for one or more patients. In addition to the advantages described herein, this technique may be used to automatically or semi-automatically set the orientation between the upper and lower arches with the bite register, possibly eliminating the step of placing the castings in maximum intercuspation prior to the scan.

In another embodiment, dimples or other physical characteristics may be incorporated at known locations within an impression tray prior to scanning the impression tray. In particular, the impression tray may be scanned to generate a digital model of the impressions from a patient. The dimples or other physical characteristics of the impression tray may be used to aid the registration of the physical impression to the scanned impression. As described below in great detail, manufacturing facility 12 may further translate these physical characteristics to the casting during the formation of the casting; thus, allowing the registration to be maintained when placing the casting into a robotic device for automatic bracket placement per the digital model generated from the impression containing the dimples.

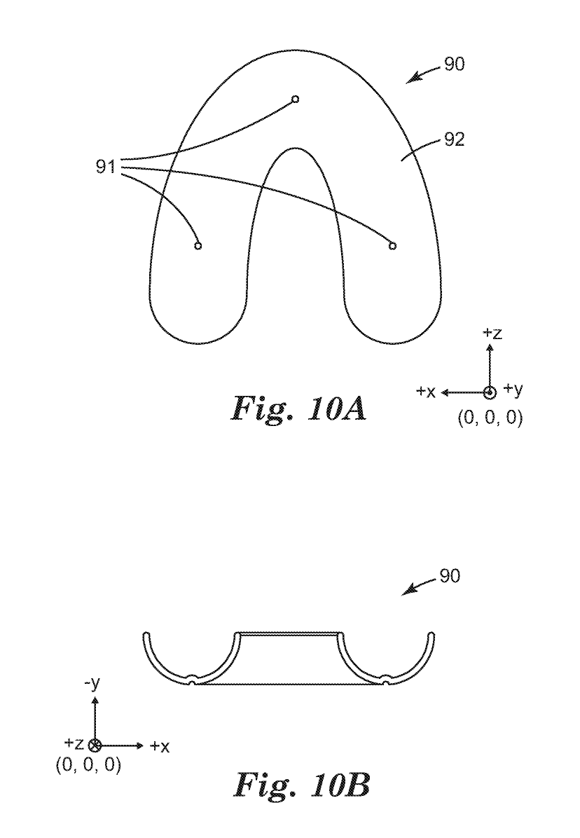

FIGS. 10A and 10B illustrate views of an exemplary impression tray 90 with three hemispherical dimples 91 in the occlusal surface 92 of the tray, from an occlusal and distal view respectively. The impression tray 90 is then mounted in a tripod configuration onto a main pedestal (not shown in FIGS. 10A and 10B), which has pillars or posts that correspond in shape and location to dimples 91 of impression tray 90. Dimples 91 may be of various shapes in various locations as long as they correspond with the pillars of the main pedestal.

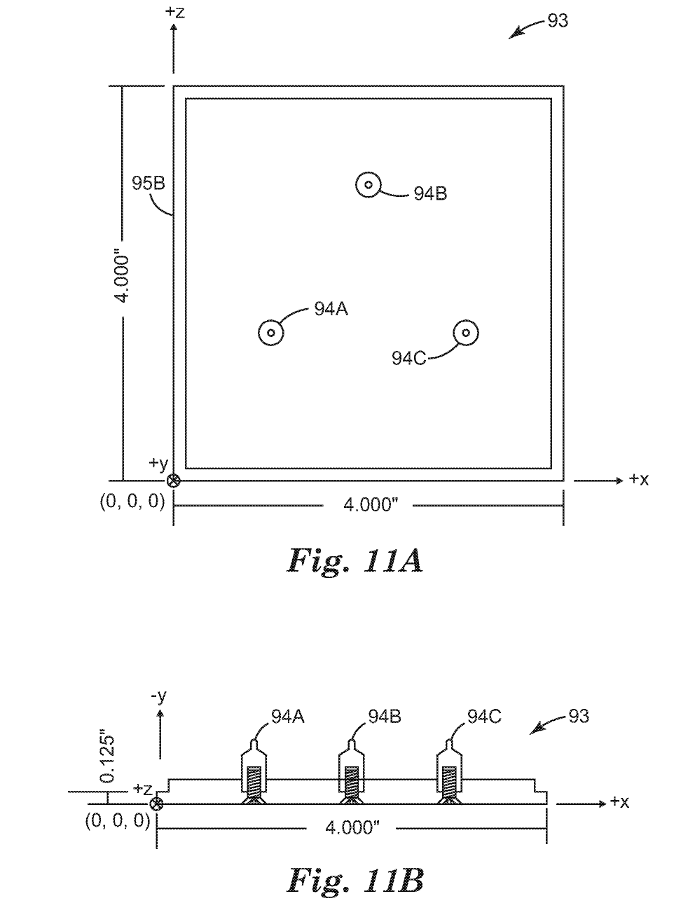

FIGS. 11A and 11B illustrate views of an exemplary main pedestal 93 with three pillars (posts) 94A, 94B and 94C, from a top and rear elevation view respectively. Main pedestal 93 (and three pillars 94A, 94B, 94C, upon which the impression tray sits), offer a corner and edges to which the points of the three pillars, and consequently all points in the dental impression, are registered in Cartesian space.

Next, in this example, since main pedestal 93 is a rectangular prism (except for material that is cut-out from the upper perimeter for the enclosing wall), the main pedestal mates into a right-angled corner of a scanner bed. Providing that such a right-angled corner is defined as the (0, 0, 0) origin of the scanner, and both the positive x- and positive z-axes extend parallel to and in the same direction as each of edges 95A, 95B of main pedestal 93, the main pedestal assumes the coordinate system of the scanner. Since main pedestal 93 is at a known location and orientation within the scanner, the impression tray, mounted to the main pedestal, is also oriented to the coordinate system of the scanner. Furthermore, utilization of additional right-angled corners of the scanner bed enables simultaneous scanning of multiple impressions.

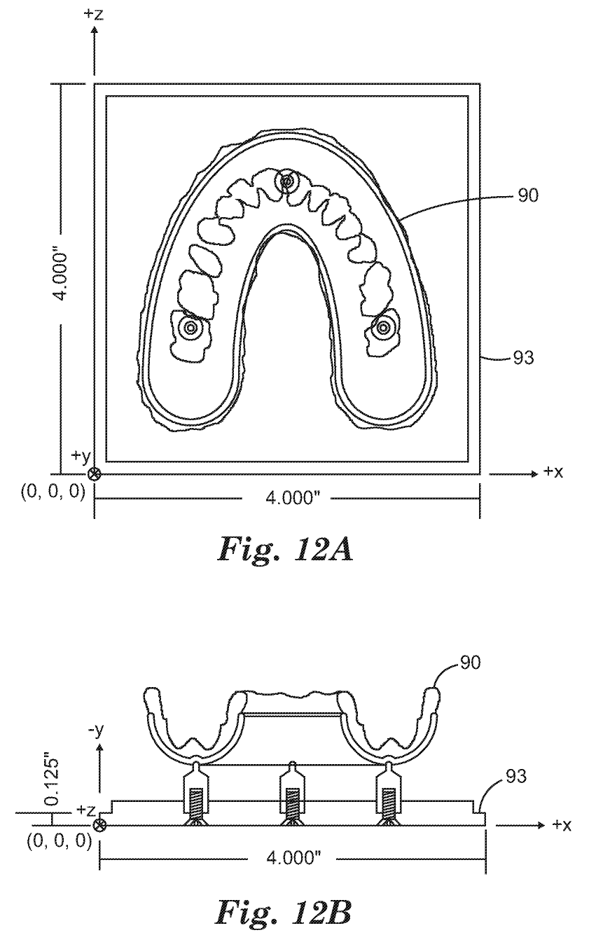

FIGS. 12A and 12B illustrate views of an exemplary impression tray attached to an exemplary main pedestal, from a top and rear elevation view respectively. In particular, FIG. 12A is a top view and FIG. 12B is a side view of impression tray 90 attached to main pedestal 93.

In order to form a casting model that remains in registration with the dental impression and the digital model, the casting formation process may utilize an inverted pedestal that sits atop an enclosing wall that rests on the main pedestal. In this example, the enclosing wall is shaped like a rectangular tube that is open at opposite ends (top and bottom) and fits into the cut-out perimeter of the top of the main pedestal. The height of the enclosing wall is constant about its circumference.

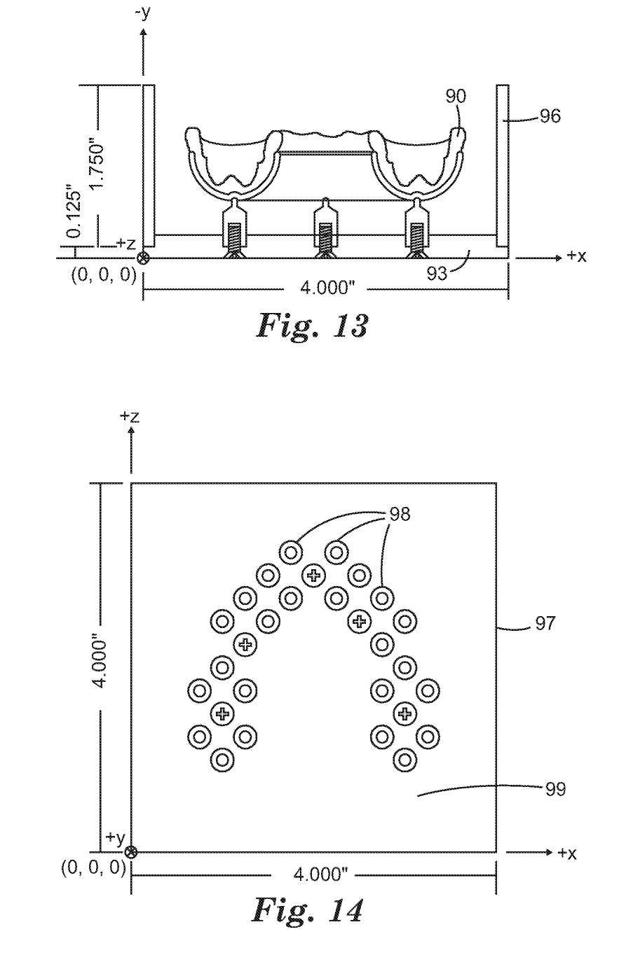

FIG. 13 illustrates a rear elevation view of an exemplary enclosing wall 96 resting on main pedestal 93 with attached impression 90. The enclosing wall 96 may be fitted into a cut-out perimeter of a top of main pedestal 93 either before or after pouring liquid casting material into the impression.

One purpose of the enclosing wall is to provide a constant vertical translation from the bottom of the main pedestal to the top of an inverted pedestal that rests atop the enclosing wall. The top of the inverted pedestal later becomes the bottom of the same pedestal as the inverted pedestal is inverted and placed on the bed of the multi-axis robot. Both the inverted pedestal and the main pedestal have cut-out perimeters to fit the enclosing wall and allow the enclosing wall to rest completely in the depths of the cutouts. Because the thicknesses (or heights) of the pedestals, the depths of their cut-out perimeters, and the height of the enclosing wall are all of known, constant dimensions, the distance between the bottom of the main pedestal and the top of the inverted pedestal is also a constant, known distance. This distance becomes an important translation when transforming coordinates between different machine coordinate systems. Another purpose of the enclosing wall, especially with regard to its joinery with the pedestals, is to keep the inverted pedestal in precise alignment with the main pedestal. The enclosing wall keeps a constant distance between the bottom planes of both pedestals and also keeps the pedestals from otherwise rotating or translating with respect to one another.

To maintain registration after pouring the casting material, the inverted pedestal forms a connection with the casting. Thus, prior to use, the inverted pedestal is drilled and tapped with a number of threaded holes for receiving machine screws.

FIG. 14 is a top view of an exemplary inverted pedestal 97 drilled with holes 98 (only a subset are labeled in FIG. 13 for simplicity and clarity). Holes 98 are tapped with machine threads for receiving screws. After pouring the casting material into the impression, inverted pedestal 97 is fitted to the top of enclosing wall 96, and three or more screws are threaded into holes 98. Hole location and depth may be based on the following criteria: the screws are adequately spaced apart from one another, each screw descends into the liquid casting material without coming into contact with the area where the casting material contacts the impression material, and each screw descends into the casting material sufficiently far to be held strongly when the casting material solidifies. An inverted pedestal fabricated from a clear solid material, such as Lexan® (polycarbonate plastic) or Plexiglass (acrylic plastic), may facilitate viewing through the inverted pedestal, making it easier to meet the above criteria. If using a photopolymer casting material, a clear inverted pedestal also allows transmission of an external light source for curing the casting material.

Since a top-most surface 99 of inverted pedestal 97 (FIG. 14) might otherwise later come into contact with a manufacturing fixture for automatic bracket placement, the top-most surface of the inverted pedestal is sufficiently displaced from the drilled and tapped surface of the inverted pedestal to prevent screw-heads from intersecting the plane intended for contact with the robotic device or CNC equipment. A surrounding wall extending vertically with a constant height from the inverted pedestal achieves this displacement. In order to ensure proper registration, the surrounding wall of the inverted pedestal extends to the same perimeter as the enclosing wall and main pedestal.

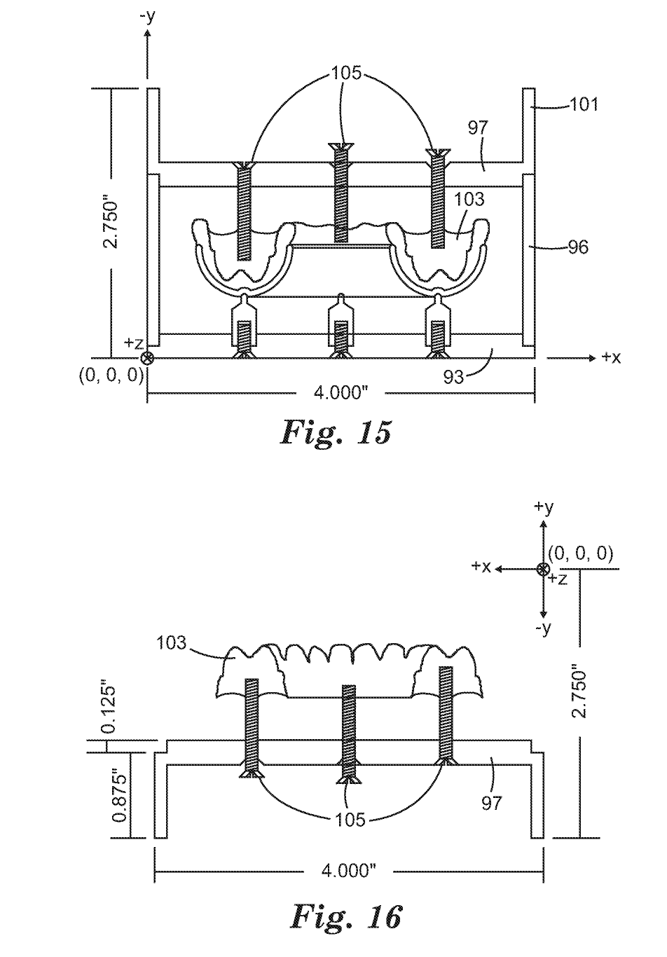

FIG. 15 is a rear elevation view of an exemplary inverted pedestal 97 with surrounding wall 101 fitted and properly aligned with screws 105 strategically located and threaded into casting material 103, upon main pedestal 93, with enclosing wall 96. As liquid casting material 103 cures into a solid, screws 105 secure the position of casting 103 with respect to inverted pedestal 97.

Consequently, the distance between the casting and the inverted pedestal becomes fixed, regardless of whether the screws are turned or not (because both the holes in the inverted pedestal and the holes formed in the casting have the same thread). Further, due to the multiplicity of screws, the torque resulting from the turning of a single screw does not cause the casting to rotate with respect to the inverted pedestal. These features make it possible to remove the casting from the inverted pedestal and later restore the casting's position without error, if desired, provided that the same assembly of parts is used to help the screws enter the casting with the same number of threads between the casting and the inverted pedestal.

After the liquid casting material cures into a solid, an operator at manufacturing facility 12 removes the inverted pedestal from the enclosing wall and main pedestal. The impression (and impression tray) will likely remain attached to the casting until the operator applies force to separate the casting from the impression tray. The operator then inverts the inverted pedestal and places the inverted pedestal on a fixture of manufacturing equipment such that the surrounding wall of the inverted pedestal is in contact with the manufacturing fixture and the occlusal surfaces of the teeth in the casting are facing up. Since, in this example, the inverted pedestal is a rectangular prism, similar to the main pedestal (except for material that is cut-out from the [now] upper perimeter), the inverted pedestal is mated into a right-angled corner on the fixture of manufacturing equipment, such as a multi-axis robotic device. Providing that such a right-angled corner is defined as (0,−2.75, 0) [in this example only] in the coordinate system of the robot, and each positive axis extends parallel to and in the same direction as each edge of the rectangular prismatic inverted pedestal, the inverted pedestal assumes the coordinate system of the robot with a single translation.

FIG. 16 is an inverted rear elevation view of an exemplary inverted pedestal 97 with screws 105 securing the position of the solid casting 103.

An alternative embodiment of the invention uses registration markers arbitrarily placed directly on three or more of the patient's teeth prior to forming the impression. In this embodiment, manufacturing facility 12 need not attach pedestals to the castings, since clinic 8 attaches the registration markers directly to the patient's teeth. After the markers are in place, techniques of this embodiment involve scanning the impression or utilizing an intra-oral scanner to scan the patient's tooth structure to generate a digital model of the tooth structure. The registration markers on the patient's teeth are used to register the digital model with the physical impression. Alternatively, a casting may be created from the impression formed from the patient's teeth having markers. During the casting formation, the markers transfer to the casting such that a scan of the casting generates a digital model of the tooth structure, and the registration markers on the patient's teeth are used to register the digital model with the physical casting.

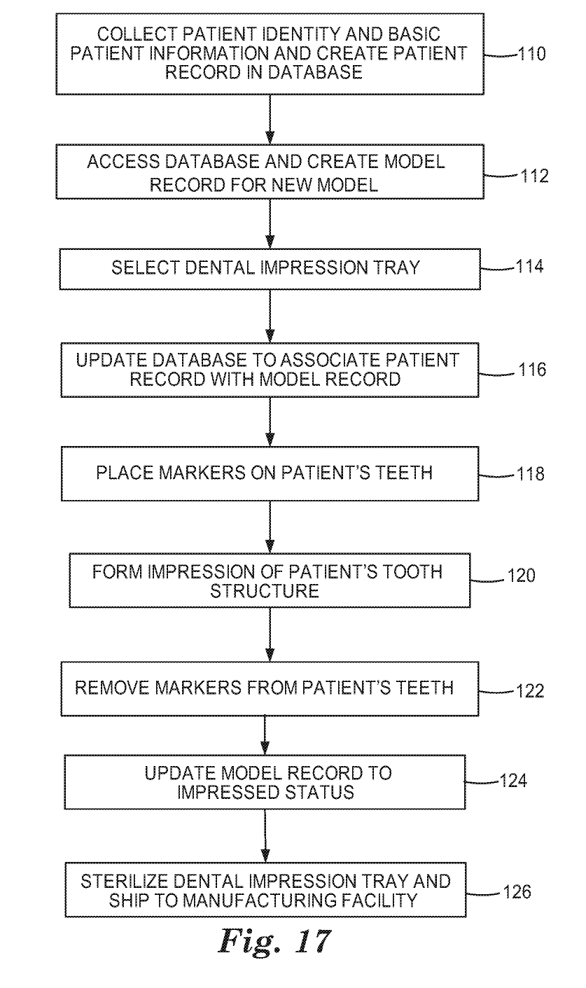

FIG. 17 is a block diagram illustrating an exemplary process at clinic 8 for placing registration markers directly on a one or more of the patient's teeth prior to forming the impression. Practitioner at clinic 8 collects patient identity and creates patient record in database (110). Next, the practitioner at clinic 8 creates a new model record (112) and selects a dental impression tray (114). The practitioner then updates the database to associate patient record with model record (116).

Prior to forming the impression, an orthodontist of clinic 8 places markers on the patient's teeth (118). In this embodiment, three registration markers may be attached to each of the upper and lower arches. At least three types of markers may be utilized for this registration technique; a metallic hemispherical bracket, a cured hemisphere of adhesive, or a light transmitting marker bracket, and the markers may be placed on a single tooth or distributed across different teeth. The cured hemisphere of adhesive contains a polymeric substance such as an orthodontic adhesive, a dental restorative, or a cyanoacrylate.

Next, the orthodontist of clinic 8 forms an impression of the patient's tooth structure after all tooth markers are in place (120). The orthodontist of clinic 8 then removes the markers from the patient's teeth (122). In one embodiment, marker attachment does not require any etching or priming of the teeth. As a result, removal of the markers may involve minimal trauma to the patient. The practitioner of clinic 8 then updates the model record to an “impressed” status (124), and sterilizes and ships impression tray 10 to manufacturing facility 12 (126). Manufacturing facility 12 scans in the impression with markers to generate a digital model of the patient's tooth structure. As an alternative to scanning the impression of the teeth with the markers, the orthodontist of clinic 8 may utilize an intra-oral scanner to scan the teeth with markers.

An alternative embodiment of the invention involves forming the patient's impression, without placing markers on the patient's teeth, and then arbitrarily placing registration markers onto the formed impression. Yet another alternative embodiment involves forming the patient's impression, without placing markers on the patient's teeth, forming a casting from the impression, and then arbitrarily placing registration markers onto the formed casting. After placing the registration markers onto the impression or casting, manufacturing facility 12 scans the impression or casting with registration markers to generate a digital model of the impression or casting with attached registration markers.

Typically, the scanned model generates a point cloud data file. Manufacturing facility 12 surfaces the point cloud data file, and may use one of several commercial software packages. For example manufacturing facility 12 may utilize a software package under the trade designation of “Wrap” or “Studio” available from Raindrop Geomagic, Inc. of Durham, N.C. Once the point cloud is surfaced, a 3D digital model of the tooth structure exists in the computer. Manufacturing facility 12 utilizes a software algorithm to identify the registration markers for registering a coordinate system of the physical model of the tooth structure to a coordinate system of the 3D digital model.

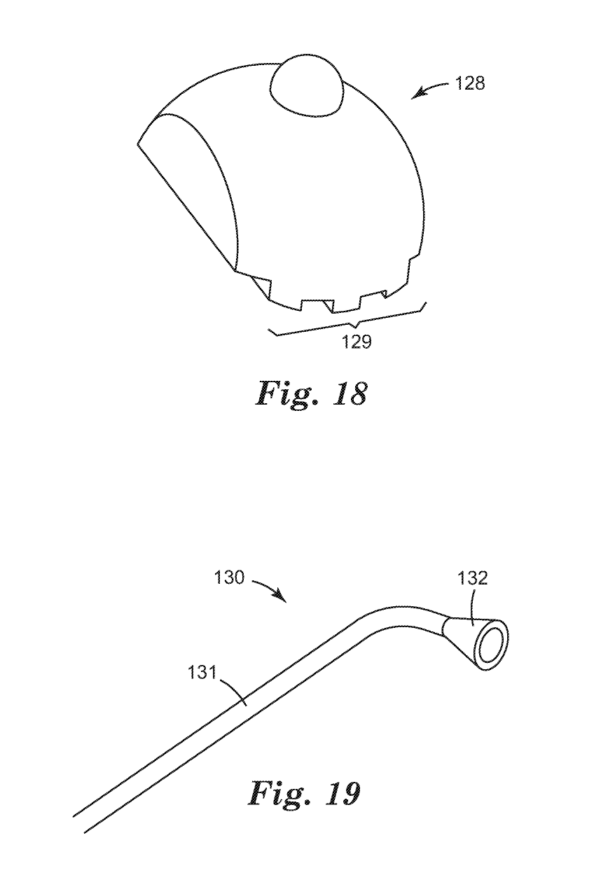

FIG. 18 is a perspective view of an exemplary metallic hemispherical marker bracket 128, which has a machined base 129 that may be affixed to the patient's teeth prior to scanning. A bracket manufacturer may add a bonding pad pre-coated with orthodontic adhesive to machined base 129. The orthodontist of clinic 8 manually attaches metallic hemispherical bracket 128 with adhesive to the patient's tooth. Alternatively, the orthodontist may attach a light curable adhesive to bracket 128 and utilize a light transmitting marker tool to attach marker bracket 128 to the patient's tooth.

Another type of marker is a light transmitting marker bracket that an orthodontist may attach to the surface of the tooth by using a light transmitting marker tool and a light curable adhesive such as Transbond adhesive. The light transmitting marker bracket may be a ceramic or metal bracket with a transparent channel cut through the bracket. Alternatively, the orthodontist may cure a hemisphere of light curable adhesive to the tooth with the light transmitting marker tool, such that the hemisphere of adhesive serves as the registration marker.

In some embodiments, hemispherical bracket 128 may be attached to banded appliances instead of a tooth. In this embodiment, the bonding pad may be designed to adhere to a metallic surface of the banded appliance or preformed such that the bracket is preformed to the banded appliance. In other embodiments, hemispherical bracket 128 may be pyramidal in shape, with a blunt tip for patient comfort. The pyramidal shape may have a base of any number of side, with preferably 4 sides.

FIG. 19 is a perspective view of an exemplary light transmitting marker tool 130 for attaching a light transmitting marker to a tooth of a patient prior to scanning. The marker tool consists of a handle 131 and a clear bell housing 132. The handle may be constructed of any stiff material, but is preferably constructed of a light transmitting material such as a fiber optic light guide. The clear bell housing allows a large percentage of light to transmit through the housing. The bell housing has a hemispherical cup cut into the housing.

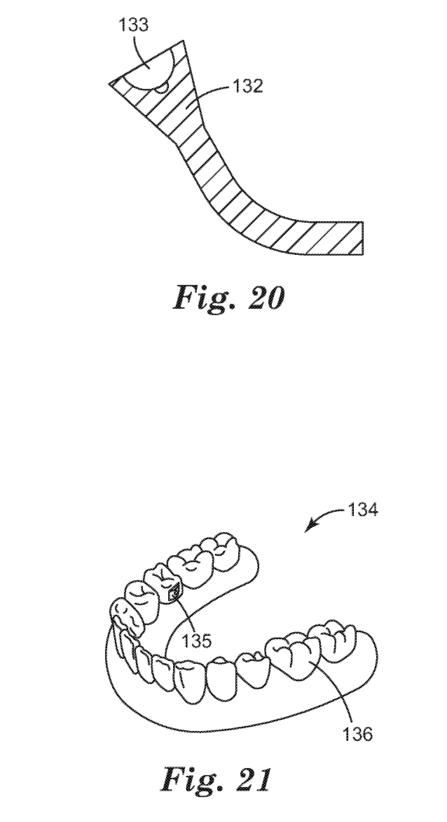

FIG. 20 is a cross section of the hemispherical cup 133 coupled to bell housing 132 of light transmitting marker tool 130 for placement on a tooth. The orthodontist of clinic 8 fills cup 133 with a light curable adhesive (such as a dental or orthodontic adhesive or a dental restorative) and uses handle 131 to place the adhesive against the surface of the tooth. In some embodiments, the adhesive alone may be the registration marker. For example, the adhesive may include metalized particles capable of being detected within the scan data. Alternatively, the orthodontist of clinic 8 may attach a light transmitting marker bracket to the cup and use the handle to place the bracket against the surface of the tooth to cure the adhesive with attached bracket into place on the tooth. After the adhesive cures, the orthodontist of clinic 8 removes the marker tool from the patient's mouth.

In other embodiments, hemispherical cup 133 may be attached to a banded appliance similar to that of hemispherical bracket 128 of FIG. 18. The adhesive for attaching cup 133 to a metallic surface may be different from the adhesive needed to fix the cup to a tooth surface.

FIG. 21 is a perspective view of a surfaced 3D digital model 134 with a hemispherical marker bracket 135 on a virtual tooth structure 136. Manufacturing facility 12 utilizes a software algorithm to identify the marker brackets for registering a coordinate system of the physical model of the tooth structure to a coordinate system of the 3D digital model. In one embodiment, a high-pass filter masks out the lower density impression or casting material in order to identify the hemispherical markers that are of a higher density. Next, an algorithm computes the centroid of each sphere. In another embodiment, an operator visually identifies each hemispherical marker bracket in the scan and uses a virtual probe to sample four or more points from each hemisphere. Next, a simple sphere equation determines each hemisphere center.

Clinic 8 then uses the registered digital model for virtual bracket placement and/or to assist automatic or semi-automatic manufacturing process. Prior to automatically placing the physical brackets onto the casting which contains the markers, manufacturing facility 12 registers the casting with the robotic system. In one embodiment, a physical probe attached to the robot samples four or more points from the surface of each hemispherical marker and computes the hemisphere centers in a manner similar to that of the virtual probe described above. The physical probe may be a touch-trigger probe or a laser-range finder. Next, transform software, such as the Best-Fit Alignment feature in Raindrop Geomagic Studio, transforms the data points in the scanned model from scanner coordinates to robotic coordinates. Now, manufacturing facility 12 may utilize the registered digital model for automatic orthodontic bracket placement onto the casting by replacing the robotic physical probe with an end-effector for placing orthodontic brackets onto the casting in the same relative positions and orientations specified in the virtual world. Alternatively, the registration process of this embodiment may be implemented with hemispheres attached to a pedestal that is physically bonded to the casting.

Alternatively, manufacturing facility 12 may utilize a CNC machined plate as a fixture for the casting during robotic placement of the brackets onto the casting. In order to do so, manufacturing facility 12 may fabricate a CNC machined plate that has the surface profile of the patient's teeth machined into the plate. The digital model is used as a geometric pattern to control the CNC device to form the surface profile in the plate.

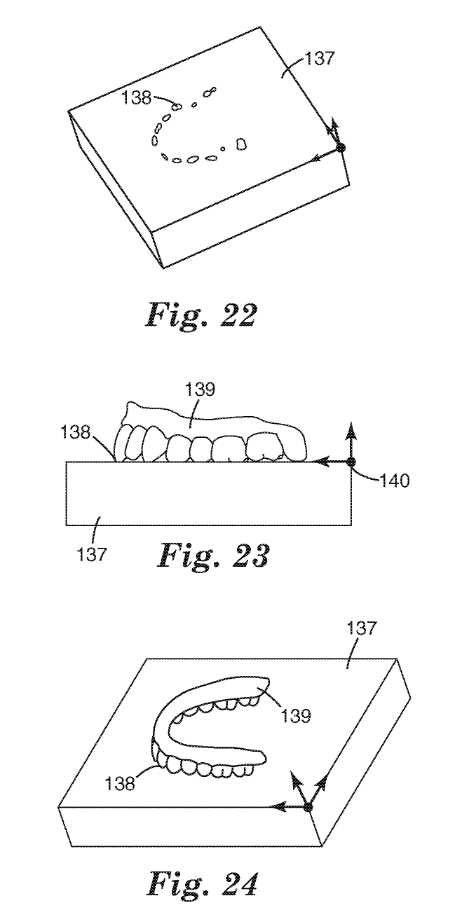

FIG. 22 is a perspective view of an exemplary CNC machined plate 137 with surface profile 138 machined into plate 137. After machining surface profile 138, the casting may be set into surface 138 on plate 137.

FIG. 23 is a side view of a casting 139 set into the machined surface 138 of plate 137. The corner of the plate, 140, represents a coordinate system of the plate, which has a known location with respect to the patient's surface profile machined into the plate. Thus, when manufacturing facility 12 places the casting into the surface of the plate, all six degrees of freedom for the casting are known with respect to the corner coordinate system. Furthermore, the digital model is registered to the corner coordinate system because the location of the CNC surface data is known with respect to the corner coordinate system.

FIG. 24 is a perspective view of casting 139 set into machined surface 138 of plate 137. After robotic equipment places the brackets onto casting 139, manufacturing facility 12 forms indirect bonding tray 16 on casting 139 and forwards the tray to clinic 8 for use on patient 6.

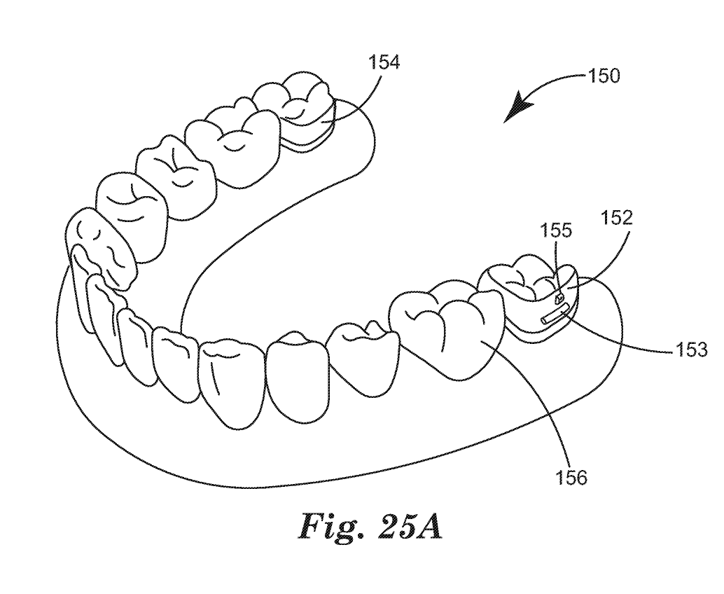

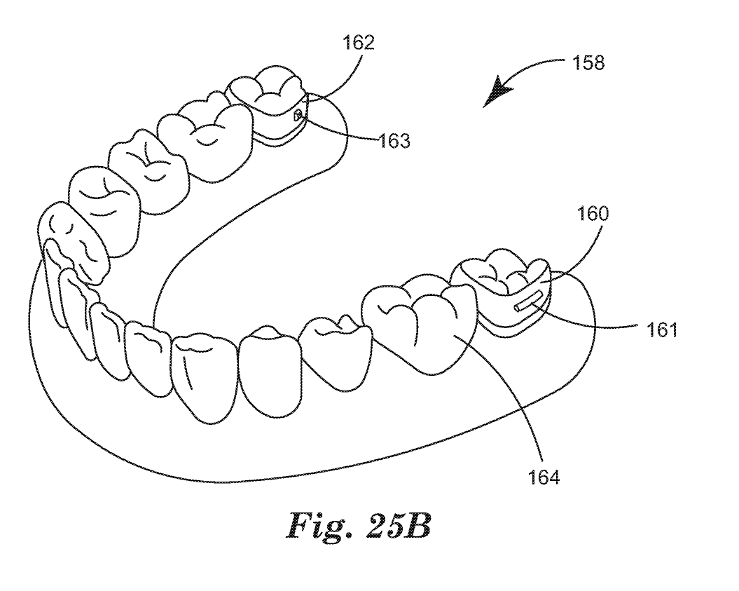

FIGS. 25A and 25B are perspective views of exemplary patient teeth 150 and 158 with respective banded appliances. In some embodiments described below, the registration methods described herein may also be used with banded appliances used for treatment planning using digital orthodontics. In the example of FIG. 25A, banded appliances 152 and 154 are attached to patient's tooth structure 156 of patient teeth 150. Banded appliance 152 represents any form of orthodontic appliance fixable to a tooth by way of a band. In this example, banded appliance 152 includes buccal tube 153 and a marker 155 used for registration purposes. In general, marker 155 has a shape that allows the position and orientation of a virtual representation of the marker, and therefore banded appliance 152, to be determined within a 3D environment. As shown herein, marker 155 is hemispherical in shape. In other embodiments, marker 155 may be pyramidal in shape, with a blunt tip for patient comfort. The pyramidal shape may have a base of any number of side, with preferably 4 sides. Banded appliance 154 also includes a buccal tube and marker (not shown) similar to banded appliance 152 that are located on the buccal side of banded appliance 154.

For purposes of illustration, banded appliance 152 is described in detail below, while banded appliance 154, or any other banded appliance not shown, may be substantially similar. Banded appliance 152 wraps partially or completely around one tooth and is typically constructed of a metal alloy capable of molding to a shape of the tooth it encompasses. Banded appliance 152 also includes buccal tube 153, on the outside or buccal side of tooth structure 156, which may accept a wire used to align other teeth in tooth structure 156. Banded appliance 152 may include other structures such as hooks or bars that aid in aligning tooth structure 156. Banded appliance 152 also includes marker 155 that is used for registering an impression of tooth structure 156 to a digital model of tooth structure 156, as described below. Marker 155 may be formed onto banded appliance 152 during appliance construction (such as adhesive binding, welding, or soldering), or the marker may be attached to the appliance by the dentist. In one embodiment, marker 155 may be located near the top of the tooth, away from the gum line of the patient, on the buccal side of tooth structure 156. As an alternative, both the tube, a lingual tube, and the marker can be attached to the lingual side of tooth structure 156.

In the example of FIG. 25B, banded appliances 160 and 162 are attached to patient's tooth structure 164 of patient teeth 158. Banded appliance 160 includes buccal tube 161 located on the buccal side of tooth structure 164 and a marker (not shown) located on the inside, or lingual side, of tooth structure 164. Banded appliance 162 includes marker 163 on the lingual side of tooth structure 164 and a buccal tube (not shown) located on the lateral side of tooth structure 164. In other words, banded appliances 160 and 162 each include a buccal tube and marker located on opposite sides of the respective banded appliances. As an alternative, the tube may be attached to the lingual side of the teeth and the marker to the buccal side of tooth structure 164. Banded appliances 160 and 162 may include other structures such as hooks or bars that aid in aligning tooth structure 164. Buccal tube 161 and marker 163 are substantially similar to buccal tube 153 and marker 155 of FIG. 25A.

As shown in FIGS. 25A or 25B, banded appliances 152, 154, 160, and 162 are fixed to their respective tooth structures 156 and 164 in order to anchor other orthodontic fixtures to the tooth structure. Markers 155 and 163 are fixed to respective banded appliances 152 and 162 for the purpose of registering an impression made of tooth structures 156 and 164 to digital models of the tooth structures, similar to the method of FIGS. 2, 3A and 3B. Banded appliances 160 and 162 of tooth structure 164 are the preferred embodiment and are described in detail below. However, any type or number of banded appliances such as banded appliances 152 and 154 may also be used. The registration of markers such as markers 155 and 163 is performed in a similar manner of other registration markers described herein, such as the registration described in FIG. 21.

In some embodiments, three or more markers may be necessary for effective registration of a virtual model of the tooth structure within a 3D environment. Additional markers may be attached to banded appliances 152, 154, 160, or 162 for registration. In alternative embodiments, registration markers such as markers bracket 128 may be attached to other teeth of the patient's tooth structure 156 or 164 for registration purposes.

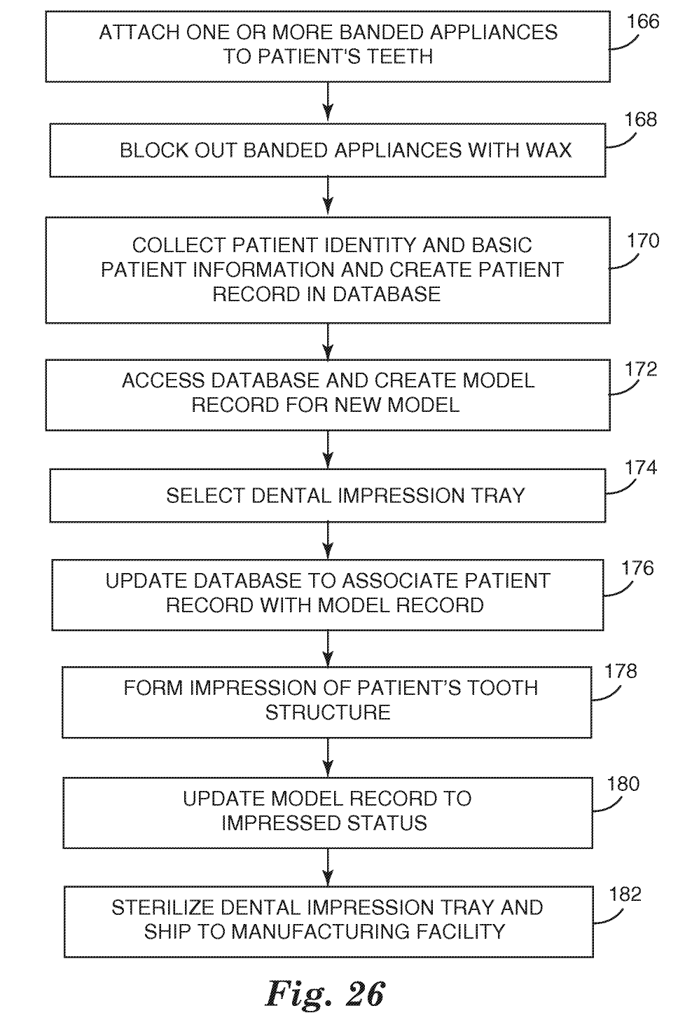

FIG. 26 is a flow diagram illustrating an exemplary technique to form a dental impression of teeth with banded appliances, e.g., at an orthodontic clinic. As shown in the example of FIG. 26, an impression is formed of tooth structures 164 of FIG. 25B. Initially, a practitioner at clinic 8 selects desired banded appliances 160 and 162 of appropriate size to fit over the respective teeth of tooth structure 164, and the practitioner then attaches the banded appliances to the tooth structure of patient 6 (166). Banded appliances 160 and 162 are preferably permanently fixed to tooth structure 164 for the duration of the treatment. Once attached, the practitioner blocks out the buccal tubes or other structures of banded appliances 160 and 162 with a blocking substance, i.e., wax (168). Wax is used to block out, or cover, structures of banded appliances such that an impression made of tooth structure 164 may be removed without locking into the blocked structures. If the impression material forms around structures, it may cure in a shape that locks the impression to the tooth structure, i.e., inhibits early impression removal. The practitioner must be careful to not block out registration markers that enable the impression to be registered to a digital model of tooth structure 164.

The practitioner then collects patient identity and other information from patient 6 and creates a patient record (170). As described, the patient record may be located within clinic 8 and optionally configured to share data with a database within manufacturing facility 12. Alternatively, the patient record may be located within a database at manufacturing facility 12 that is remotely accessible to clinic 8 via network 14.

When capturing an impression of the tooth structure of patient 6, or shortly before or after, practitioner at clinic 8 creates a model record for the new model (172). The term model refers to any replication of the patient's tooth structure, for example the impression, bite registration, the casting, and/or the 3D digital model of the tooth structure. Practitioner at clinic 8 selects a dental impression tray (174) and then updates the database to associate the appropriate patient record with the model record (176). This model record resides in the database and tracks the status and all variations of data of the patient's tooth structure. The practitioner of clinic 8 then utilizes dental impression tray 10 to form an impression of the patient's tooth structure (178) and updates the model record to the “impressed” status (180). Often times, a patient requires orthodontic treatment on both the upper and lower arches. In this case, practitioner at clinic 8 selects impression tray 10 for each arch (174), forms an impression of each arch (178), associates a model record with each arch (176), and updates model record to “impressed” status for each arch (180). Clinic 8 sterilizes or disinfects impression tray 10 and ships the tray to manufacturing facility 12 (182). Once impressions are completed, the practitioner may remove the wax from tooth structure 164.

In other embodiments, the steps of FIG. 26 may be completed in a different order. For example, the practitioner may create the patient record (170) and access the database to create a model record for a new model (172) before attaching banded appliances (166). In any embodiment, the practitioner may create an impression from tooth structure 164 while banded appliances 160 and 162 are attached.

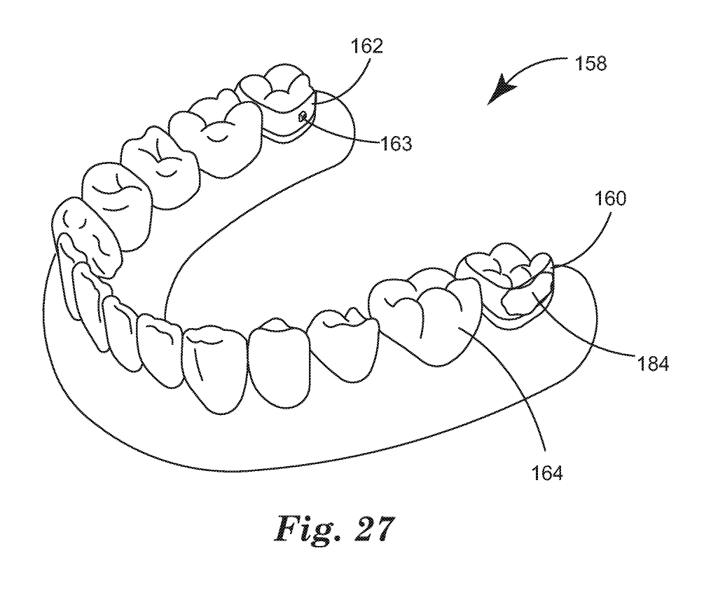

FIG. 27 is a perspective view of exemplary banded appliances blocked out with wax. In the example of FIG. 27, patient's teeth 158 includes banded appliances 160 and 162 on tooth structure 164, similar to FIG. 25B. Blocking substance 184 covers buccal tube 161 of banded appliance 160, while another blocking substance (not shown) covers the buccal tube of banded appliance 162. Blocking substance 184 also covers any other structure that may lock into the formed impression of tooth structure 164. In some embodiments, blocking substance 184 may also partially or fully cover banded appliances 160 and 162.

Marker 163 is not blocked by blocking substance to enable registration of tooth structure 164 to the digital model created from the impression. In the preferred embodiment, wax is used for blocking substance 184, but any material capable of preventing the impression of being locked onto a structure of banded appliance may be used. Blocking substance 184 may be removed from banded appliances 160 and 162 once the impression is completed. Blocking substance 184 may be applied to any banded appliance or bracket that may lock onto an impression.

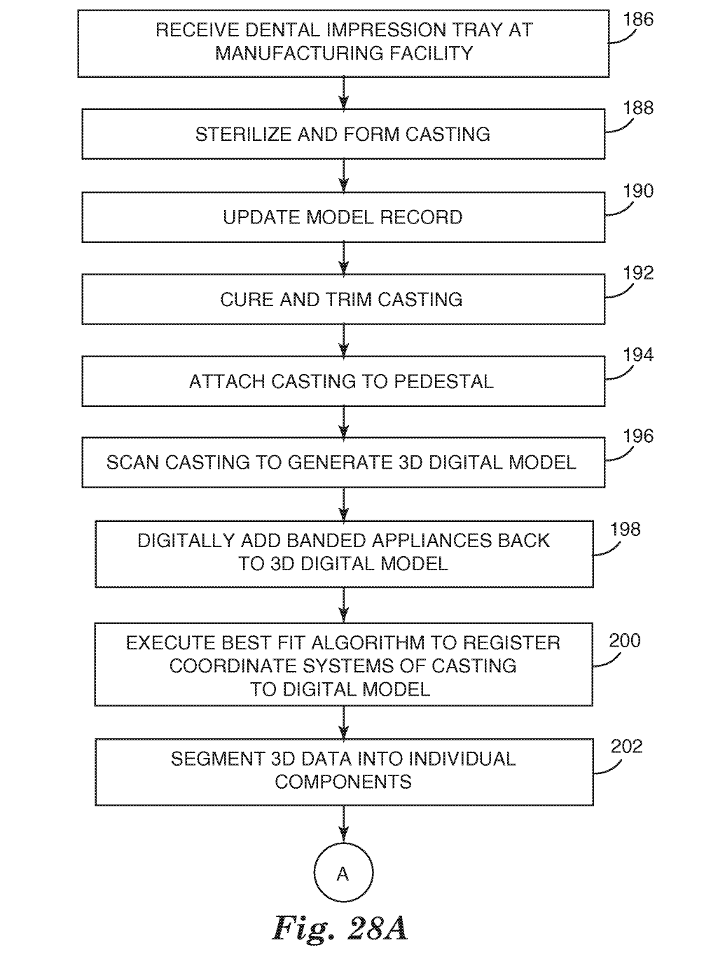

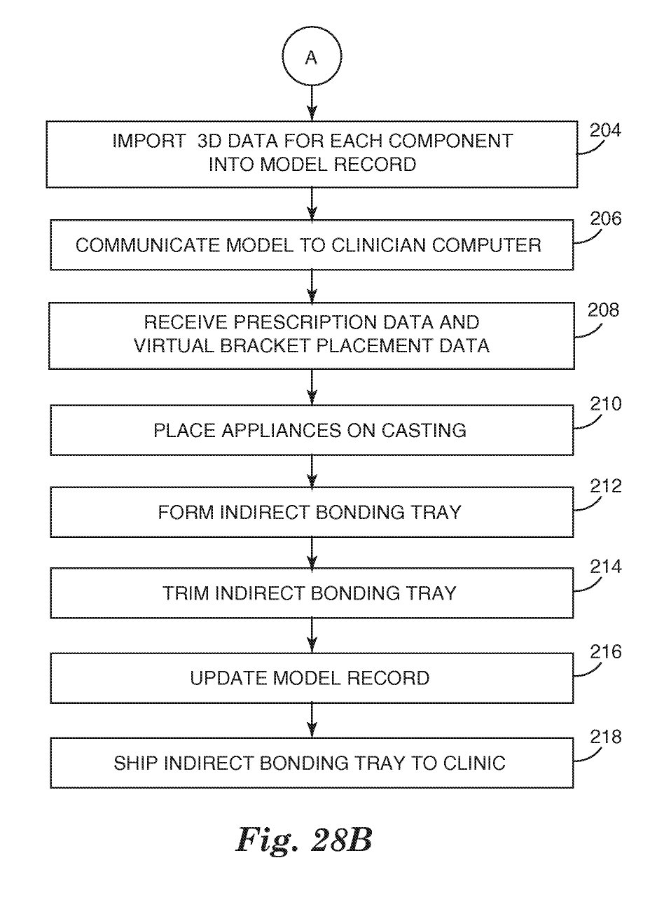

FIGS. 28A and 28B are flow diagrams illustrating an exemplary technique for creating indirect bonding trays from the impression created in FIG. 26. FIGS. 28A and 28B are substantially similar to the examples of FIGS. 3A and 3B. In the example of FIGS. 28A and 28B, manufacturing facility 12 typically receives dental impression tray 10 as part of a larger shipment containing multiple dental impressions (186). Next, manufacturing facility 12 sterilizes or disinfects the shipment of impression trays, including dental impression tray 10, and moves the dental impression trays to a casting station where castings are made from the trays (188). Manufacturing facility 12 then utilizes the same database accessed by clinic 8 to update the model record to indicate a “casting formed” status (190). Next, manufacturing facility 12 cures and trims the casting (192) and attaches a pedestal to the casting (194).

Next, manufacturing facility 12 may utilize a Computed Tomographic (CT) scanner to scan the casting (196). The casting may also be scanned with X-rays, magnetic resonance images or other scanning devices including visible light scanning devices. In cases where a patient requires orthodontic treatment on both the upper and lower arches, castings of the upper and lower arches may be scanned simultaneously (196). The scan generates a point cloud data file which manufacturing facility 12 then surfaces using one of several software packages available on the market today. For example, manufacturing facility 12 may utilize a software package called “Wrap” or “Studio” available from Raindrop Geomagic, Inc. of Durham, N.C. Once the point cloud is surfaced, a 3D digital model of the casting with pedestal exists in the computer. Manufacturing facility 12 may then modify the point cloud data to include the banded appliances 160 and 162 previously blocked out with the blocking substance (198). Manufacturing facility 12 may use the markers or information provided from the practitioner to accurately recreate the banded appliances. In some embodiments, the casting may not be attached to a pedestal, as described previously. In other embodiments, banded appliances 160 and 162 may be digitally added to the point cloud data at anytime during the process of FIG. 28A.

Manufacturing facility 12 then executes a best fit algorithm for automatic or semi-automatic registration between a 3D coordinate system of the physical casting and a 3D coordinate system associated with the digital model of the casting within a 3D modeling environment (200). For example, a computer may automate the registration process by correlating the position of physical markers located on the casting to the position of the virtual markers located in the digital model of the casting. For example, the computer may searching surface data of the scanned casting for hemispherical bumps and align the bumps with the hemispherical markers of the virtual representation of the patient's dental arch. In this manner, registration can occur directly between the physical and virtual models to align the coordinate systems of each space. In contrast to the method described in FIG. 3A, no pedestal is used for registration. Markers, such as marker 163, located on the casting may be used at any time to register the casting coordinates to the digital model coordinates without the use of any other attached structure. The registration is complete when the computer determines the best-fit orientation within a predetermined tolerance. This process may be fully automated or semi-automated in that user verification or other input may be requested. In other embodiments, the computer may search the surface data of the scanned casting for hemispherical recessions, where the marker was in indentation within a banded appliance. In alternative embodiments, the computer may search the surface data of a scanned impression for corresponding hemispherical impressions or bumps to register the impression to the digital model.

Once the coordinate systems of the physical casting and digital model of the casting are registered within the 3D environment (200), manufacturing facility 12 utilizes software to segment the digital model into individual components prior to virtual bracket placement on the digital model (202). The separation software identifies each tooth and separates the teeth from each other and from the gingiva within the 3D environment. This may be useful in allowing each tooth to independently move within the 3D environment and illustrate the predicted results of any orthodontic prescription that includes the pre-attached banded appliances 160 and 162.

Manufacturing facility 12 then imports the 3D data for each component from the digital model into the database's model record (204) and communicates the model record to clinic 8 (206). The clinic 8 utilizes the model record by choosing and placing appliances on the virtual representations of the teeth structure. An application software program then predicts the final positions of the teeth following treatment with such an appliance system based on the geometry of the appliances and the relative positions of the appliances and their corresponding teeth. Utilizing the positions of the banded appliances with respect to the respective teeth may be useful in predicting the relative positions of the banded and non-banded teeth. After clinic 8 utilizes the model record for virtual bracket placement, manufacturing facility 12 receives prescription data and virtual placement data from clinic 8 (208). The prescription data specifies the individual appliances (e.g. brackets, banded appliances, or arch wires that attach to banded appliances 160 and 162) associated with the prescription, and the virtual placement data specifies the location of the appliances within the 3D modeling environment.

Next, the physical casting and affixed pedestal travels to a manufacturing station within manufacturing facility 12, where appliances are automatically selected and applied to the casting based on the prescription data and virtual placement data (210). The registration determined between the physical casting and the virtual model of the casting may be used to ensure accurate positioning of the appliances. Further, the pedestal attached to the casting may securely mate with a predefined fixture within the manufacturing equipment to further ensure accurate appliance placement on the physical casting.

After the manufacturing equipment attaches brackets to the casting, the manufacturing facility 12 forms an indirect bonding tray (212). For example, manufacturing facility 12 may place a heated plastic sheet matrix material over the casting and the brackets so that plastic sheet material assumes a configuration that precisely matches the casting.

Next, manufacturing facility 12 trims the indirect bonding tray (214). Manufacturing facility 12 may utilize automated tray trimming equipment, such as laser or Computer Numerical Control (CNC) cutting devices, to trim the indirect bonding tray. The known geometry of the pedestals registers the coordinate system of the casting with the coordinate system of the tray trimming equipment for trimming the indirect bonding tray while it remains attached to the casting. Since the indirect bonding tray is formed on a casting that is attached to a pedestal of known geometry, the coordinate system associated with the digital representation of the casting may be transferred to a model of the indirect bonding tray, which may in turn be used to automatically control the tray trimming equipment for trimming the indirect bonding tray. At the completion of the indirect bonding tray trimming, manufacturing facility 12 updates the model record to the “trimmed” status (216). Finally, manufacturing facility 12 ships indirect bonding tray 16 to clinic 8 (218).

The embodiments of FIGS. 28A and 28B may provide more accurate treatment planning by incorporating pre-attached banded appliances into the digital model. In other words, the practitioner does not need to fit and adjust the placement of banded appliances to match the planned treatment as created using the digital model.

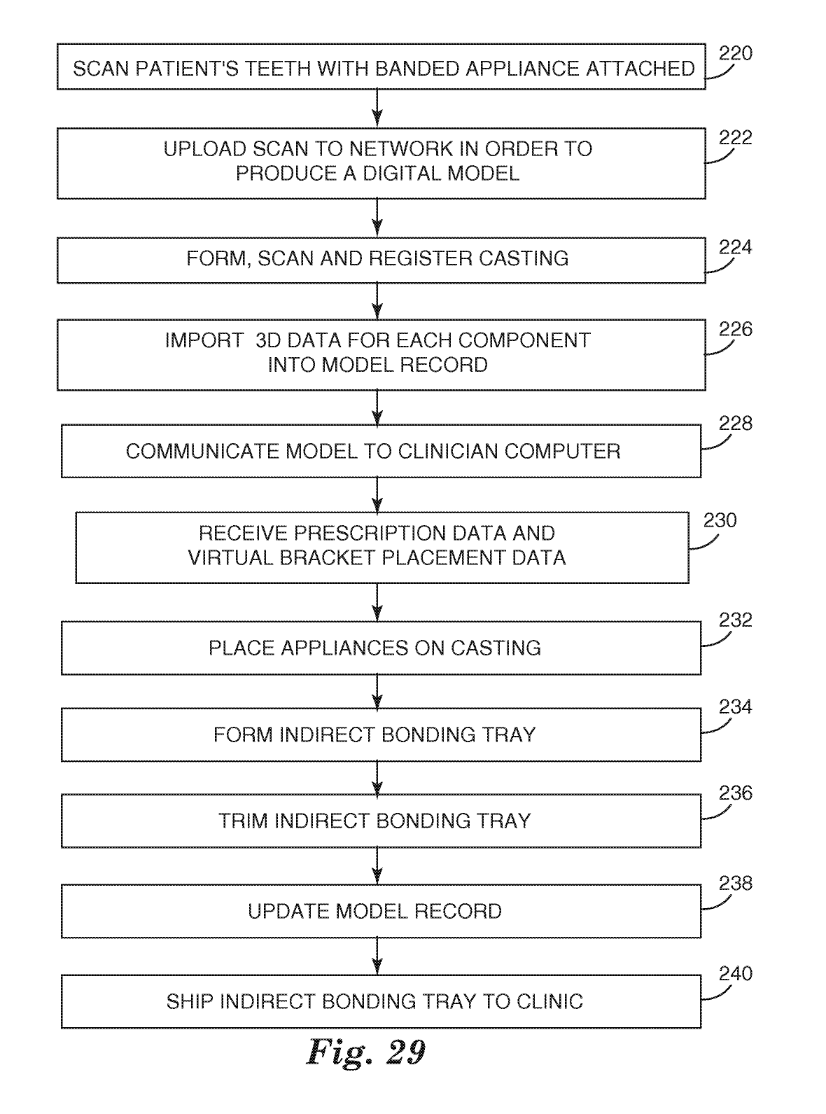

FIG. 29 is a flow diagram illustrating a second exemplary technique in which teeth with banded appliances are directly scanned, thereby eliminating the requirement of forming an impression from the dental arch. In the alternative embodiment of FIG. 29, banded appliances are attached to the tooth structure of patient 6 similar to the examples of FIGS. 25A or 25B. FIG. 25B will be used as an example in this embodiment. In some embodiments, markers attached to banded appliances 160 and 162 may not be needed for registration. Elements of the banded appliance structure, such as buccal tube 161, may be recognized in place of separate registration markers, like marker 163. In alternative embodiments, additional markers may be bonded to other teeth of tooth structure 164 for registration purposes, as previously described.

Instead of forming an impression as described in FIG. 26, the practitioner uses an intra-oral scanner to scan tooth structure 164 of patient 6 (220). The scan is then uploaded to network 14 where manufacturing facility 12 receives the scan data and creates a digital model of tooth structure 164 (222). Manufacturing facility 12 attaches a virtual pedestal to the digital model, forms a casting of the digital model, updates the model record, trims the casting, scans the casting, and registers the coordinate systems of the casting and the digital model (224). The steps of step 224 are substantially similar to steps 188-202 of FIG. 28A. Specifically, the registration of the casting to the digital model is performed by correlating the position of the markers, such as marker 163, on the casting to the markers in the digital model. In this manner, the markers allow the casting to be registered directly to the digital model, without the use of another attached structure of known dimensions or coordinates. In other embodiments, structures of banded appliances 160 and 162 may be used to register the casting with the digital model. Alternatively, the formed casting may already be registered to the digital model because the casting was formed in a coordinate system already registered. The casting may be created with a rapid-prototyping technique, such as stereolithography. In some embodiments, the casting may be formed separately, without being formed attached to a pedestal.

The remaining steps of the example of FIG. 29 are substantially similar to the example of FIG. 3B. Manufacturing facility 12 imports the 3D data for each component from the digital model into the database's model record (226) and communicates model record to clinic 8 (228). The clinic 8 utilizes the model record by choosing and placing appliances on the virtual representations of the teeth. An application software program then predicts the final positions of the teeth following treatment with such an appliance system based on the geometry of the appliances and the relative positions of the appliances and their corresponding teeth. Utilizing the positions of the banded appliances with respect to the respective teeth is may be useful in predicting the relative positions of the banded and non-banded teeth. After clinic 8 utilizes the model record for virtual bracket placement, manufacturing facility 12 receives prescription data and virtual placement data from clinic 8 (230). The prescription data specifies the individual appliances (e.g. brackets or arch wires to be attached to banded appliances 160 and 162) associated with the prescription, and the virtual placement data specifies the location of the appliances within the 3D modeling environment.

Next, the physical casting and affixed pedestal travels to a manufacturing station within manufacturing facility 12, where appliances are automatically selected and applied to the casting based on the prescription data and virtual placement data (232). The registration determined between the physical casting and the virtual model of the casting may be used to ensure accurate positioning of the appliances. Further, the pedestal attached to the casting may securely mate with a predefined fixture within the manufacturing equipment to further ensure accurate appliance placement on the physical casting.

After the manufacturing equipment attaches brackets to the casting, the manufacturing facility 12 forms an indirect bonding tray (234). For example, manufacturing facility 12 may place a heated plastic sheet matrix material over the casting and the brackets so that plastic sheet material assumes a configuration that precisely matches the casting.

Next, manufacturing facility 12 trims the indirect bonding tray (236). Manufacturing facility 12 may utilize automated tray trimming equipment, such as laser or Computer Numerical Control (CNC) cutting devices, to trim the indirect bonding tray. The known geometry of the pedestals registers the coordinate system of the casting with the coordinate system of the tray trimming equipment for trimming the indirect bonding tray while it remains attached to the casting. Since the indirect bonding tray is formed on a casting that is attached to a pedestal of known geometry, the coordinate system associated with the digital representation of the casting may be transferred to a model of the indirect bonding tray, which may in turn be used to automatically control the tray trimming equipment for trimming the indirect bonding tray. At the completion of the indirect bonding tray trimming, manufacturing facility 12 updates the model record to the “trimmed” status (238). Finally, manufacturing facility 12 ships indirect bonding tray 16 to clinic 8 (240).

The embodiment of FIG. 29 may provide more accurate treatment planning by incorporating pre-attached banded appliances into the digital model. In this case, the practitioner does not need to fit and adjust the placement of banded appliances to match the planned treatment as created using the digital model. In addition, the steps of FIG. 29 allow a casting to be created without the use of an impression as previously described. Impressions may be uncomfortable for a patient and inaccurate when formed over banded appliances because of the blocking substance used to block out at least a portion of the banded appliances. To avoid these difficulties, generating castings from a digital model may be beneficial as a reduction in time, labor costs, and patient discomfort.

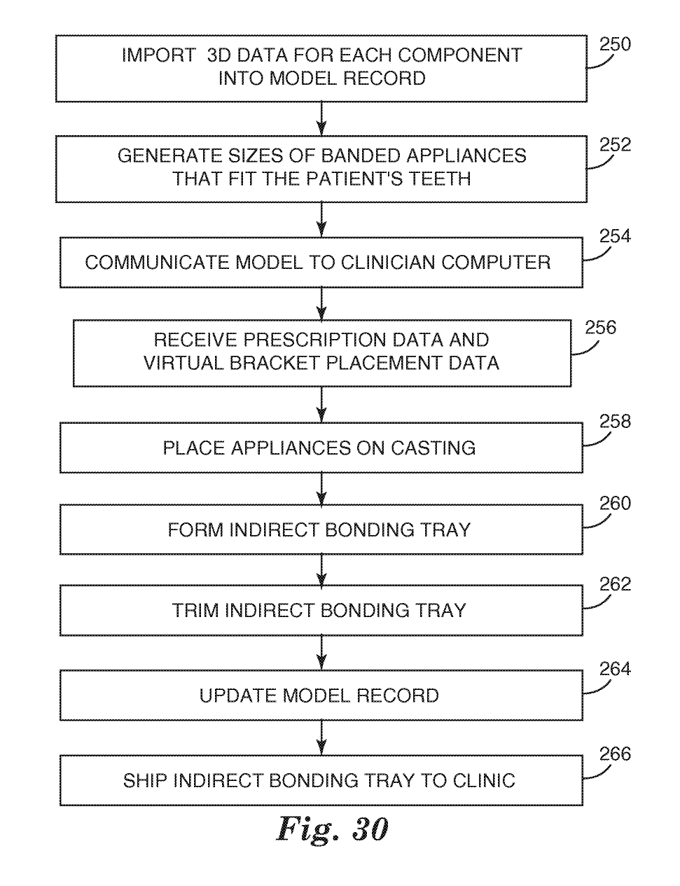

FIG. 30 is a flow diagram illustrating another exemplary technique in which the practitioner selects the specific banded appliances for inclusion within the indirect bonding tray. In the embodiment of FIG. 30 selecting and including banded appliances to the indirect bonding tray is described. Banded appliances may be used in place of or in addition to other brackets. The procedure begins with creating an impression of the tooth structure of patient 6 and generating a casting and digital model, substantially similar to the example of FIGS. 2 and 3A.

After the example of FIG. 3A, manufacturing facility 12 imports the 3D data for each component from the digital model into the database's model record (250). A computer, with possible feedback from a technician, is used to generate sizes of banded appliances that may fit teeth of the tooth structure. The computer includes software that may measure tooth circumferences to automatically select band sizes of the banded appliances to attach to patient 6. The practitioner may use this data to select types of banded appliances to include in the indirect bonding tray. Selecting band sizes is described in detail in commonly assigned U.S. Pat. No. 6,089,868, entitled “Selection of Orthodontic Appliances”, issued Jul. 18, 2000 to Russel A. Jordan et al., and U.S. Pat. No. 6,350,119, entitled “Selection of Orthodontic Appliances,” issued Feb. 26, 2002 to Russel A. Jordan et al., both of which are hereby incorporated by reference.

Manufacturing facility 12 next communicates the model record to clinic 8 (254). After clinic 8 utilizes the model record for virtual bracket and banded appliance placement, manufacturing facility 12 receives prescription data and virtual placement data from clinic 8 (256). The prescription data specifies the individual appliances (e.g. brackets, banded appliances or arch wires) associated with the prescription, and the virtual placement data specifies the location of the appliances within the 3D modeling environment.

Next the physical casting and affixed pedestal travels to a manufacturing station within manufacturing facility 12, where appliances are automatically selected and applied to the casting based on the prescription data and virtual placement data (258). Interproximal areas on the casting may have to be opened to accept the bands. The registration determined between the physical casting and the virtual model of the casting may be used to ensure accurate positioning of the appliances. Further, the pedestal attached to the casting may securely mate with a predefined fixture within the manufacturing equipment to further ensure accurate appliance placement on the physical casting, similar to FIG. 3B.

After the manufacturing equipment attaches brackets and banded appliances to the casting, the manufacturing facility 12 forms an indirect bonding tray (260). For example, manufacturing facility 12 may place a heated plastic sheet matrix material over the casting, brackets, and banded appliances so that plastic sheet material assumes a configuration that precisely matches the casting.

Next, manufacturing facility 12 trims the indirect bonding tray (262). Manufacturing facility 12 may utilize automated tray trimming equipment, such as laser or Computer Numerical Control (CNC) cutting devices, to trim the indirect bonding tray. The known geometry of the pedestals registers the coordinate system of the casting with the coordinate system of the tray trimming equipment for trimming the indirect bonding tray while it remains attached to the casting. Since the indirect bonding tray is formed on a casting that is attached to a pedestal of known geometry, the coordinate system associated with the digital representation of the casting may be transferred to a model of the indirect bonding tray, which may in turn be used to automatically control the tray trimming equipment for trimming the indirect bonding tray. At the completion of the indirect bonding tray trimming, manufacturing facility 12 updates the model record to the “trimmed” status (264). Finally, manufacturing facility 12 ships indirect bonding tray 16 to clinic 8 (266).

In some embodiments, the casting may be dissolved or cracked to remove the attached banded appliances from the casting. This may be necessary due to possibly tight fits of the banded appliances over the respective teeth of the casting. In other embodiments, banded appliances may not be fitted to the casting. Since banded appliances fit snuggly over each respective tooth, the banded appliances may be precisely placed to the indirect bonding tray after the bonding tray is removed from the casting.

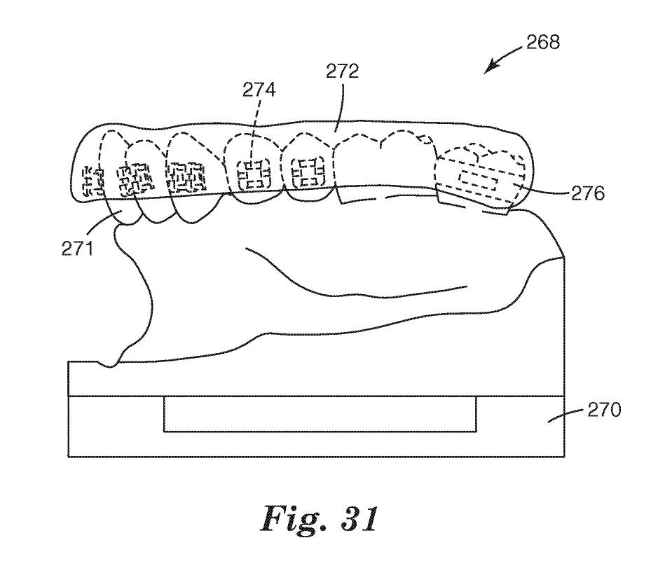

FIG. 31 is a perspective view of an exemplary indirect bonding tray that includes banded appliances. In the example of FIG. 31, casting assembly 268 includes casting 271 on pedestal 270 with attached brackets 274, banded appliances 276, and an indirect bonding tray 272 formed over casting 271. Banded appliances 276 include buccal tubes, and may also include markers for registration. In some embodiments, the separation between casting 271 and pedestal 270 may be at a different point than shown in FIG. 31.

In another embodiment, a pedestal having embedded fiducial markers may be used to assist registration. For example, the pedestal may be constructed from plastic and have three or more beads embedded at known locations within the pedestal. The beads may be constructed of steel, lead, or any other material that may be detected by a scanning device and distinguished from the surrounding pedestal. The computer detects the scanned beads, and registers the physical model of the casting to the virtual model of the casting based on the known location of the fiducial markers within the pedestal. The process (described in FIGS. 2, 3A and 3B) and the advantages described herein apply to this alternative technique of FIG. 31.

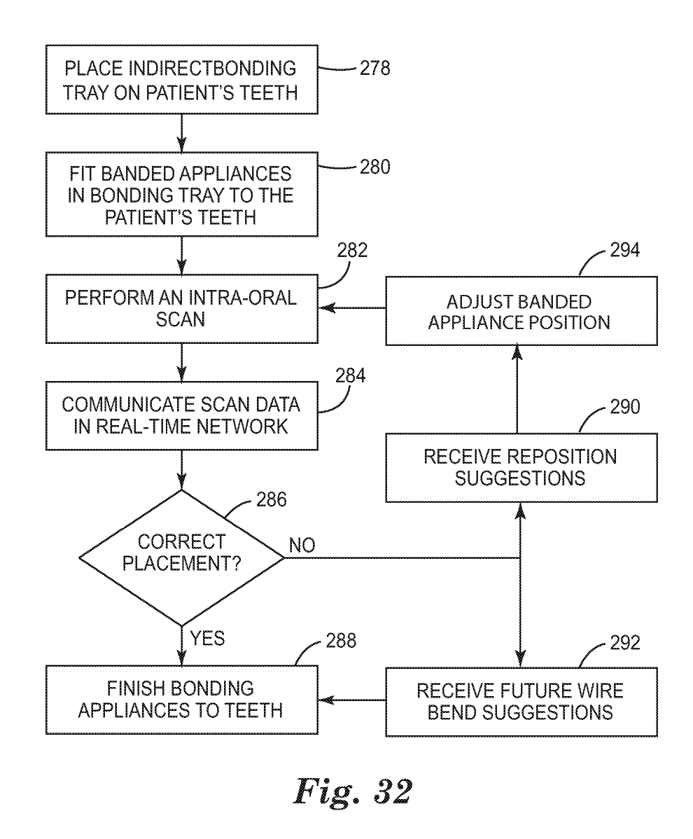

FIG. 32 is a flow diagram of an exemplary technique for checking banding appliance placement after the banded appliances have been fixed to a patient's tooth structure using an indirect bonding tray. In the example of FIG. 32, the practitioner may place an indirect bonding tray 272 of FIG. 31 to the patient's tooth structure (278). During placing, the practitioner may fit the banded appliances located in the bonding tray to the appropriate teeth (280). In some cases, the banded appliances may fit directly onto the respective teeth without difficulty. In other cases, the practitioner may need to individually fit each banded appliance if the appliances are too tight to be fitted with the indirect bonding tray.

After the brackets, banded appliances, and wire of indirect bonding tray are fitted, the practitioner performs an intra-oral scan of the appliances (282). A computer creates scan data and communicates the scan data to network 14 in real-time (284). The practitioner may interrogate the digital model and scan data to determine if the brackets and banded appliances have been placed correctly on the teeth of patient 6 (286). If the appliances have been correctly placed, the practitioner finishes boding the appliances to the teeth and continues with the treatment (288). If the placement is incorrect, the practitioner may have a few options. One option is for the practitioner to receive reposition suggestions from the network for the one or more appliances (banded or brackets) that are misplaced (290) so that the practitioner may adjust the position of the appliances (294). The other option is for the practitioner to receive future wire bend suggestions from the network (292) to avoid repositioning any appliances. The practitioner may then finish bonding the appliances to the patient's teeth (288).

In some embodiments, the practitioner may perform teeth scanning periodically during the fit process to guide the practitioner into correctly placing each appliance the first time. In other embodiments, markers may be attached to banded appliances to aid is registering the scan data to the digital model. In any embodiment, the practitioner may perform scans multiple times in order to correctly place each appliance.

Various implementations and embodiments of the invention have been described. Nevertheless, it is understood that various modifications can be made without departing form the invention. These and other embodiments are within the scope of the following claims.

1. A method comprising:
attaching at least one banded appliance to a tooth structure of a patient, wherein the banded appliance comprises a marker fixed to the banded appliance at a known location;
forming a casting from an impression of the patient's tooth structure having the marker; and
registering the casting to a digital model of the tooth structure based on the known location of the marker.

2. The method of claim 1, further comprising blocking out the banded appliances with a blocking compound, wherein the markers remain exposed so as to form corresponding indent regions in the impression.

3. The method of claim 2, further comprising inserting a digital representation of the blocked out banded appliances to the digital model.

4. The method of claim 1, further comprising scanning the impression to generate the digital model of the tooth structure.

5. The method of claim 1, further comprising forming the marker out of the banded appliance.

6. The method of claim 1, further comprising adhesively attaching the marker to the banded appliance.

7. The method of claim 1, further comprising utilizing the digital model for machining the tooth structure into a plate utilized for automatic placement of orthodontic appliances.

8. The method of claim 1, further comprising registering the casting and the digital model to a manufacturing device using the known location of the marker.

9. The method of claim 1, determining the location of the marker relative to a manufacturing device using a touch-trigger probe or a laser-range finder.

10. The method of claim 1, further comprising utilizing a robotic manufacturing device for automatic placement of an orthodontic appliance onto the casting corresponding to a position of the banded appliance.

11. The method of claim 1, further comprising forming an indirect bonding device upon the casting.

12. A method comprising:
attaching one or more banded appliances to a tooth structure of a patient;
scanning the patient's tooth structure with the one or more banded appliances attached to the tooth structure;
generating a digital model of the tooth structure from the scan based on known locations of the banded appliances; and
generating a casting based upon the digital model.

13. The method of claim 12, further comprising attaching a marker to at least one of the one or more banded appliances.

14. The method of claim 13, further comprising registering a location of a physical replica from the marker in the casting to a location of a virtual representation of the marker in the digital model to register coordinate systems of the casting and the digital model.

15. The method of claim 14, further comprising registering the casting and the digital model to a manufacturing device with known locations of the one or more banded appliances.

16. The method of claim 15, wherein the manufacturing device comprises one or more of the following to determine the locations of the banded appliances in manufacturing device coordinates: a touch-trigger probe and a laser-range finder.

17. The method of claim 15, further comprising utilizing a robotic manufacturing device for automatic bracket placement onto the casting, wherein the bracket placement is determined based upon the one or more banded appliance positions.

18. The method of claim 17, further comprising forming an indirect bonding device upon the casting.

19. A method comprising:
attaching markers to a tooth structure of a patient;
forming an impression of a tooth structure of a patient having the attached markers;
generating a casting from the impression;
registering the casting to a digital model of the tooth structure based on known location of the markers; and
utilizing a robotic manufacturing device for automatic placement of banded appliances onto the casting.

20. The method of claim 19, further comprising forming an indirect bonding tray upon the casting.

21. The method of claim 19, further comprising utilizing a robotic manufacturing device for automatic placement of brackets onto the casting.

22. The method of claim 20, further comprising placing the banded appliances within the indirect bonding tray onto the patient's tooth structure

23. The method of claim 22, further comprising scanning the patient's tooth structure with the banded appliances in place to generate placement data.

24. The method of claim 23, further comprising comparing the placement data to the automatic placement onto the casting.

25. A system comprising:
a respective marker attached to one or more banded appliances attached to a tooth structure of a patient;
a casting of the tooth structure having the attached banded appliances; and
a computer that registers the casting to a digital model based on known locations of the markers.

26. The system of claim 25, further comprising a scanner that scans the patient's tooth structure with the attached markers to generate a digital model of the tooth structure.

27. The system of claim 25, further comprising a scanner that scans the casting to generate a digital model of the tooth structure.

28. The system of claim 25, wherein the respective marker comprises a cured adhesive mound.

29. The system of claim 25, wherein the marker comprises a light transmitting marker.

30. The system of claim 25, wherein the marker comprises a metallic hemispherical marker.

31. The system of claim 25, further comprising an indirect bonding tray comprising one or more brackets.

32. An orthodontic banded appliance comprising:
a metallic pyramidal marker; wherein the marker comprises a bonding surface for bonding the marker to the orthodontic banded appliance.

33. An orthodontic banded appliance comprising:
a light transmitting marker, wherein the marker comprises a bonding surface for bonding to the orthodontic banded appliance.

34. An orthodontic device comprising:
an indirect bonding tray that is formed around a casting of a tooth structure of a patient;
one or more brackets embedded in the indirect bonding tray; and
one or more banded appliances embedded in the indirect bonding tray.

35. A computer-implemented system comprising:
a computer providing an operating environment for an orthodontic treatment software application that registers a virtual representation of a banded appliance to a respective virtual representation of a tooth based on a location of a registration marker on the banded appliance, and wherein the software application predicts a final position of the tooth and allows a practitioner to plan an orthodontic prescription treatment based upon the prediction.
